(19) United States
(12) Patent Application Publication
(10) Pub. No.: US 2025/0071573 A1
(43) Pub. Date: Feb. 27, 2025

(54) DYNAMIC NETWORK SLICING FOR WIRELESS NETWORKS USING CLUSTERING AND PACKET INSPECTION

(71) Applicant: Charter Communications Operating, LLC, St.Louis, MO (US)

(72) Inventors: Mohamed Daoud, Aurora, CO (US); Hany Heikal, Aurora, CO (US); Hossam Hmimy, Aurora, CO (US)

(21) Appl. No.: 18/236,383

(22) Filed: Aug. 21, 2023

(51) Int. Cl. H04W 24/02; H04L 41/16

(52) U.S. Cl. CPC H04W 24/02; H04L 41/16

(57) ABSTRACT

Methods and apparatus for using an artificial intelligence engine to automatically predict what network slices will be needed are described. After the network slice prediction is made network slices are automatically generated in accordance with AI machine learned prediction. This new automated approach ensures the network slices are up to date and devices assigned the network slices properly as the new devices get activated on the network. This new approach can also add elasticity to the network slices based on the devices assigned to them by changing the amount of resources allocated to slices of a particular type as predicted resource needs change.

### FIELD

The present application relates to communications methods and, more particularly, to methods and apparatus for automatically generating network slices, e.g., in accordance with AI machine learned predictions of needs for slices by the network.

### BACKGROUND

Network slicing is a 3GPP feature to create multiple logical networks over one common shared infrastructure. Each logical network is designed to serve a certain purpose and has all the required network resources. In 3GPP three categories of services are defined such as eMBB (enhanced Mobile Broadband), mMTC (massive Machine Type Communications) and URLLC (Ultra-Reliable and Low Latency Communications). To support these services, KPIs (Key performance Index) such as user experience data rate, peak data rate, mobility, latency, connection density, energy efficiency, and traffic volume density have to be considered since these parameters will be different based on the type of service. Each slice will have different configuration to support each of the mentioned use cases.

Currently slices are manually created by network operators ad devices are assigned to each slice manually based on the operator knowledge of their use cases. For example, the operator can create a network slice for IoT and manually assign the IoT sensor devices to it as these devices will require low throughput and are latency tolerant, while the operator can create another slice for Fixed Wireless Access (FWA) users and manually assign devices to it that will require high throughput and low latency.

The processes of creating slices, adding users, and performing slice management are time-consuming tasks since each slice needs network resources (e.g., UPF, SMR, RAN and transport) to be provisioned. To provide resources for different network slices, a Network Slice Blueprint is defined for a network slice instance. Network slice Blueprint is a description of the structure, configuration and the plans, workflows to instantiate and control the Network Slice Instance during its life cycle. The Network Slice Blueprint enables the instantiation of a Network Slice, which provides certain network characteristics. A network Slice Blueprint refers to required physical and logical resources.

Based on the above discussion, there is a need for new methods and apparatus for creating, updating and managing network slices. It would be beneficial if at least some of these new methods and apparatus were performed automatically or with minimal operator involvement.

### BRIEF DESCRIPTION OF THE FIGURES

FIG. 1 is a drawing of an exemplary communications system in accordance with an exemplary embodiment.

FIG. 2 is a drawing illustrating exemplary components, connections and interfaces in an exemplary communications system including a 5G core network.

FIG. 3 is a drawing which provides a functional representation of inputs, outputs and operations performed in accordance with the present invention, e.g., to generate a refined set of network slices using AI along with showing some system components and steps used in one exemplary embodiment.

FIG. 4 is a drawing illustrating exemplary architecture, exemplary data capture and an AI engine producing network slice blueprints, in accordance with an exemplary embodiment.

FIG. 5 is a 5G Quality of Service Indicator (5QI) table which lists QoS characteristics in 5G for a plurality of different 5QI values.

FIG. 6A is a first part of an exemplary network slice blueprint code example to support mobile gaming.

FIG. 6B is a second part of an exemplary network slice blueprint code example to support mobile gaming.

FIG. 6 comprises the combination of FIG. 6A and FIG. 6B.

FIG. 7 illustrates a first example of dynamic network slicing in which the network has 4 slices that equally use the 5G core resources.

FIG. 8 illustrates a second example of dynamic network slicing, in which the network has been updated to now have 3 slices instead of 4, and in which one slice utilizes more resources than each of the other two slices, said second network slicing being a result of AI based slice updates including resource re-allocations, in accordance with the present invention.

FIG. 9 is a drawing of an exemplary artificial intelligence (AI) engine in accordance with an exemplary embodiment.

FIG. 10 is a drawing of an exemplary compute node in accordance with an exemplary embodiment.

FIG. 11 is a drawing of an exemplary operations support systems (OSS) in accordance with an exemplary embodiment.

FIG. 12 illustrates a first clustering technique that is used in some embodiments.

FIG. 13 illustrates a second clustering technique that is used in some embodiments.

FIG. 14A illustrates a first part of a flow chart showing steps implemented in accordance with an exemplary embodiment.

FIG. 14B illustrates a first part of a flow chart showing steps implemented in accordance with an exemplary embodiment.

FIG. 14 is a diagram showing how the flow chart portions shown in FIGS. 14A and 14B are combined to form a complete flow chart.

### SUMMARY

Methods and apparatus for automatically predicting the need for various types of network slices and generating network slices are described. In various embodiments machine learning, e.g., clustering and/or model training, is used to gather insights into the types of slices that will be needed and/or to make predictions with regard to the need for particular types of slices and/or parameters associated with the slices. Slice blueprints which are used in slice generation are generated and used to create slices in accordance with predicted network slice needs. The slices are then allocated to UEs for use, e.g., with potentially multiple different UEs being allocated use of a portion of a network slice. The portion of a network slice allocated to an individual UE is sometimes referred to as a sub-slice or simply a slice. Similarly, while a network slice maybe and also sometimes is referred to as a slice since it is a type of slice, it should be appreciated that network slices can be and often are used by multiple UEs since they are used to implement a set of network functions or services which can be used by multiple UEs.

UE requests and UE slice utilization by individual UEs can and sometimes is used in predicting the types of network slices and/or overall resources which should be allocated to network slices. In various embodiments, a slice and slice prediction model is trained using data collected from an operating communications network, e.g., a network which is operated using an initial default set of slices which may have been generated based on insights obtained by clustering network information.

The training data may and sometimes does include labeled input in the form of captured network information corresponding to UEs which are known to use particular types of slices with various known parameters. Thus in at least some embodiments a prediction model is trained from network information and corresponding slice utilization information. Different sets of network information may and sometimes do correspond to different types of slices and/or slice parameters. Applying machine learning to the training data, e.g., labeled training data, allows a slice and slice parameter prediction model to be trained from actual network information. The model can be and sometimes is updated over time with the model predicting the types of slices which will be needed and/or slice parameters. Slice blueprints corresponding to the types of slices to be generated are used, along with the corresponding predicted parameter information corresponding to the type of slice to be created, are used to automatically generate slices based on the predications.

As slices of particular types are no longer predicted to be needed, the slices are omitted from a slice generation process and the resources previously allocated to a slice which is no longer needed are reallocated to other slices which are predicted to be needed.

Based on slice and resource predictions, resources maybe and sometimes are acquired, e.g., purchased from a cloud based resource provider, and/or relinquished, e.g., with in some case a lease of unneeded resources being terminated or not renewed for a future period of time when the model predicts the slices using the resources, or a portion of the resources previously licensed, are no longer needed.

In various exemplary embodiments a plurality of different network slice default blueprints e.g., a live stream network slice default blueprint, a gaming network slice default blueprint, a smart phones network slice default blueprint and a machines network slice default blueprint, are stored. Initially network resources are configured to provide a variety of different network slice instances of different types in accordance with the network slice default blueprints. A network slice blueprint specifies service requirements, network functions, network slice instance node information including resource requirements, resource allocation information, service level agreement information and/or orchestration information. Different network slice blueprints have different features, have different requirements and specify different network functionality/capabilities that are supported by a network slice instance, generated from a corresponding network slice blueprint. Different network slice blueprints are intended to support different types of devices and/or applications and/or service requirements.

Network resources are initially configured to provide a first set of network slice instances, each network slice corresponding to different one of the network slice blueprints. For example, initially the available network resources can be divided, e.g., equally between 4 different network slices, a first slice intended to support live streaming and referred to as a live streaming slice, a second slice intended to support gaming and referred to as a gaming slice, a third slice intended to support smart phones and referred to as a smart phones slice and a fourth slice intended to support robotic machines and referred to as a machines slice.

During a first time period in which UEs are assigned to slices, UE capability information received during initial attach messages is collected, 5G QoS flow information, e.g., 5QI information, is collected and application type information, e.g., traffic type information, is collected via packet inspection at a user plane function (UPF). In addition, actual slice utilization is monitored for each of the slices including monitoring utilization of individual resources allocated to implementing the slices. As should be appreciated the initial set of slices may not fully align with UE utilization of the slices resulting in resources allocated to some slices going unused and potentially with some UEs being unable to receive service because of insufficient allocation of resources to slices of the type needed to support some UEs.

In accordance with one feature, the information collected during the first time period is used as training data to train a slice and resource utilization prediction model, e.g., an AI based model used to predict slices and corresponding resources which are required given a predicted set of slices are used, e.g., with parameters corresponding to individual network slices being predicted for each of the different types of slices to be generated. The model is trained using the UE capability information received during initial attach messages, 5G QoS flow information, e.g., 5QI information, and application type, e.g., traffic type, information and actual resource usage information, with knowledge of how such inputs relate to measured slice utilization information. Information relating to an individual UE, such as UE requests, application information and information relating to QoS provided to the UE can be and sometimes is associated in the training data with UE slice utilization information. By taking into consideration the information corresponding to multiple UEs, network slice requirements can be and sometimes are predicated. This is possible since the network slices service multiple UE and therefore reflect, at least to some extent, a composite in terms of resources of the slices (also sometimes referred to as sub-slices) provided individual UEs.

In some but not necessarily all embodiments, as part of the AI model training, the received input information parameters, e.g., UE capability information received during initial attach messages, 5G QoS flow information, e.g., 5QI information, and application type information values are clustered into groups to determine a relationship between monitored input values, e.g., input parameters, and slices which are required given a particular set of inputs. The clustering of input information to utilized slices facilitates training of the model to allow the model to predict, based on detected UE capability information, 5G QOS flow information, e.g., 5QI information, the types of slices which will be needed to satisfy UE requirements and the resources which will be needed by the slices that are required.

During a second period of time, following the first period of time, UE capability information from initial attached requests is monitored, 5G QoS flow assignments and corresponding 5QI information is monitored and application type information, e.g., traffic type information, and actual usage information, is monitored. The monitored information is collected and used to train an AI model to predict the types of slices that are required to support UEs connecting to the network or otherwise seeking service and the resources which will be required by the slices. The required resources maybe and sometimes are indicated in the form of predicted parameter values associated with a slice which is predicted as being required.

If the predicted slices differ from the set of slices which are in use and/or the resources predicted to be required for individual slices is different than the resources currently allocated, one or more new network slice blueprints are created, and/or one or more existing network slice blueprints are updated, and/or one or more network slice blueprints are deleted, resulting in a new (updated) set of network slice blueprints. A new set of network slice instances are generated and implemented using the new (updated) set of network slice blueprint, said generating including assigning network functions with specified resource requirements, to particular devices. This may and sometimes does result in a change in the types of slices which are generated and used with, in some cases, use of some types of slices being discontinued and/or the use of new types of slices being created. The amount of resources allocated to a type of slice can also be changed when a given type of slice continues to be used by the blueprint for the slice is changed, e.g., because a parameter used to control the type or amount of resources used by the slice is changed from one prediction to another.

The network slice blueprint creation and/or editing combined with the subsequent process of network slice creation is implemented to reallocate the available network resources based on predicted types of slices which will be needed and predicted slice resource requirements.

As part of the process of slice creation/editing, some slice types may be discontinued and/or the amount of resources allocated to different types slices may be changed to make better use of available network resources given the slice/resource utilization predictions. The set of created slices usually includes extra capacity per slice as a safety margin beyond what is predicted allowing the resource to slice allocations and created slices to be used for an extended period of time following slice creation.

As the created/edited slices are used actual slice/resource utilization if also monitored and UE/network related information is collected. This information is used to retrain/update the slice/resource prediction model to improve its reliability, e.g., at periodic intervals, and/or in response to detecting that slices are going unused or UEs are requiring slices which have not already been created.

Consider for example where 4 different slices were created, and the information relating to the slice utilization and monitored parameters during a first period of time is used to train an AI model used to predict the types of slices and per slice resources which will be required based on input parameters which can be monitored. The input parameters are monitored for a second period of time and the based on the detected input parameters the trained slice and resource utilization model predicts that machine slice utilization will no longer be required due to a lack of robotic machines being detected during the second period of time but that the slice intended to support gaming will require additional resources due to gaming device UEs joining the network at an increased rate and seeking a greater amount of resource for gaming than was sought during the first period of time. In such a case slice creation/editing triggered automatically based on the output of the trained slice and resource prediction utilization model based on information collected during the second period of time may, and in some cases will trigger editing in the form of deletion of the machine slice and allocation of additional resource corresponding to the gaming slice. This may be, and sometimes is, achieved by automatically editing the gaming slice blueprint to include the increase in predicted network resource that will be needed by the gaming slice to support gaming UEs and by deleting the machine slice thereby allowing for the reallocation of network resource previously allocated to the machine slice to the gaming slice or other slices which the AI trained prediction model predicts will be needed.

The updating/retraining of the slice and resource prediction model and slice generation/editing based on predicted slice and resource needs can, and sometimes does, occur on a recurring basis but potentially at different rates. For example, the training/retraining of the slice and resource utilization prediction model may occur relatively infrequently, e.g., on a weekly or monthly basis using collected historical data, while the slice and resource utilization predictions may occur on a daily, hourly or even several minute or per minute basis to take into consideration the fact that UE requirements and network loading may change frequently based on the time of day and/or day of week. For example, robotic machines requiring a machines slice to support their activity may not be needed in an area during off-work hours when a warehouse or plant is shut down, while a need for increased resources for gaming slices may occur due to the workers in the area redirecting their activities from work to gaming applications.

While explained in the context of using different network slices intended to support gaming and robotic devices as well as other applications, the methods and apparatus are not limited to such types of slices and can be used to predict and automatically control the generation of a wide variety of different types of slices, e.g., corresponding to different predefined slice blueprints, with the amount of resources being allocated to different types of slices also varying depending on predicted network requirements at a given time.

It should be appreciated that all features discussed in the summary need not be included in all embodiments and that numerous variations are possible. The following detailed description discusses various exemplary embodiments in greater and provides further information on various features.

### DETAILED DESCRIPTION

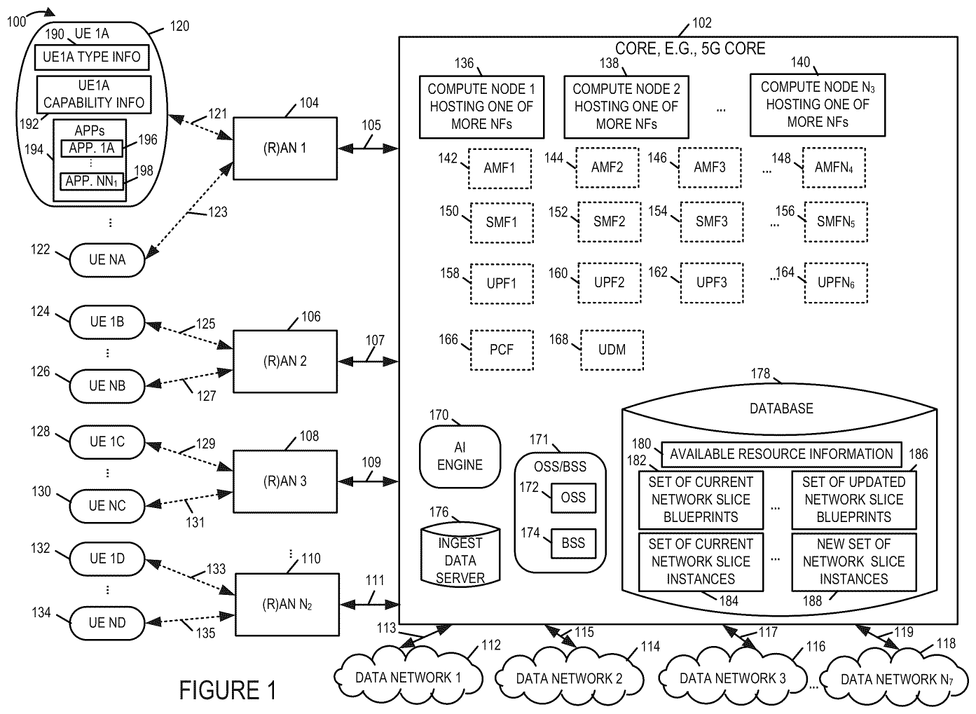

FIG. 1 is a drawing of an exemplary communications system 100 in accordance with an exemplary embodiment. Exemplary communications system 100 includes a core 102, e.g., a 5G core, a plurality of (radio) access networks ((R)ANs) ((R)AN 1 104, (R)AN 2 106, (R)AN 3 108, . . . , (R)AN N2 110), a plurality of data networks (data network 1 112, data network 2 114, data network 3 116, . . . , data network N8 118), and a plurality of user equipments (UEs) (UE 1A 120, . . . , UE NA 122, UE 1B 124, . . . , UE NB 126, UE 1C 128, . . . , UE NC 130, UE 1D 132, . . . , UE ND 134), coupled together as shown. The core network 102 is coupled to the (RANs) ((R)AN 1 104, (R)AN 2 106, (R)AN 3 108, . . . , (R)AN N2 110)) via communications links (105, 107, 109, . . . , 111), respectively, which are, e.g., wireline or fiber optic communications links. The core network 102 is coupled to the data networks (data network 1 112, data network 2 114, data network 3 116, . . . , data network N8 118) via communications links (113, 115, 117, . . . , 119), respectively, which are, e.g., wireline or fiber optic communications links. The core network 102 includes a plurality of compute nodes (compute node 1 136, compute node 2 138, . . . , compute node N3 140), an artificial intelligence (AI) engine 170, an ingest data server 176, and operations support systems (OSS)/business support system (BSS) 171 including an OSS 172 and a BSS 174, and a database 178 coupled together. The core network 102 further includes a plurality of network function (NF) instances, which are hosted on the compute nodes (136, 138, . . . , 140). The plurality of NF instances includes a plurality of access and mobility management (AMF) instances (AMF1 142, . . . . AMF2 144, AMF3 146, . . . , AMFN4 148), a plurality of session management function (SMF) instances (SMF1 150, SMF2 152, SMF3 154, . . . , SMFN5 156), a plurality of user plane function (UPF) instances (UPF1 158, UPF2 160, UPF3 162, . . . , UPFN6 164), a policy control function (PCF) instance PCF 166, a unified data management (UDM) instance UDM 168, and other 5G NFs. Ingest data server 176 includes information (e.g., user equipment device type information, user equipment device capability information, application type information (e.g., traffic type information), QoS flow assigned 5QI values, and measured slice utilization information) collected during system operation to be used as inputs into the AI engine 170. The AI engine 170 includes a model training module, e.g., a machine learning (ML) clustering algorithm such as a K nearest neighbors (KNN) clustering algorithm, which processes input data and outputs predicted slice information, e.g., information identifying the amount of resources to be allocated to different types of network slices. OSS 172 implements a set of network slice blueprints, said implementation including assigning each NF (with specific resource requirements (e.g., number of processing cores, amount of bandwidth (throughput), and amount of solid-state drive (SSD) memory) of a set of NFs, corresponding to network slice, to a compute node which is available to satisfy the resource requirements and host the NF.

Each of the (R)ANs (104, 106, 108, . . . 110) may be a radio access network (RAN), which uses wireless links to communicate with UEs, or a non-wireless access network (AN) which uses wireline or fiber connections to communicate with UEs. Exemplary (R)AN types include, e.g., gNB base stations, eNB base stations, various types of access point (APs), WiFi APs, IoT Gateways (GWs). Exemplary UEs include wireline and wireless devices. Some exemplary UEs include, e.g., cellphones, gaming devices, PCs, laptops, tablets, IoT sensor devices, IoT control devices, camera devices, security devices, etc. Each of the UEs (UE 1A 120, . . . , UE NA 122, UE 1B 124, . . . , UE NB 126, UE 1C 128, . . . , UE NC 130, UE 1D 132, . . . , UE ND 134) include device type information, device capability information, and a set of applications. For example, UE1A 120 includes UE1A type information 190, UE1A capability information 192, and set of applications 194 (application 1A 196, . . . , application NN1 198). The UEs (UE 1A 120, . . . , UE NA 122) are coupled to (R)AN 1 104 via communications links (121, . . . , 123), respectively. The UEs (UE 1B 124, . . . , UE NB 124) are coupled to (R)AN 2 106 via communications links (125, . . . , 127), respectively. The UEs (UE 1C 128, . . . , UE NC 130) are coupled to (R)AN 3 108 via communications links (129, . . . , 131), respectively. The UEs (UE 1D 132, . . . , UE ND 134) are coupled to (R)AN N2 110 via communications links (133, . . . , 135), respectively. During initial attachment of a UE, e.g., UE1A 120, device type information, e.g., UE1A type information 192, and device capability information, e.g., UE1A capability information 192, is communicated, e.g., via link 121, (R)AN 104, link 105, and an AMF to the core 102 and stored in ingest data server 176. When a 5G device, e.g., sends a data request for services, the 5G network assigns a 5QI value to be used for a QoS flow corresponding to the service request and QoS flow with the assigned 5QI is mapped to a 5G data radio bearer (DRB) which is to carry the QoS flow having the assigned 5QI, and the assigned 5QI value for the QoS flow is collected and stored in the ingest data server 176. UPFs perform packet inspections (e.g., deep packet inspection (DPI) of layer 7 (application layer) and capture the application type (e.g., traffic type) from the inspection, and the identified application type information is collected and also stored in the ingest data server 176.

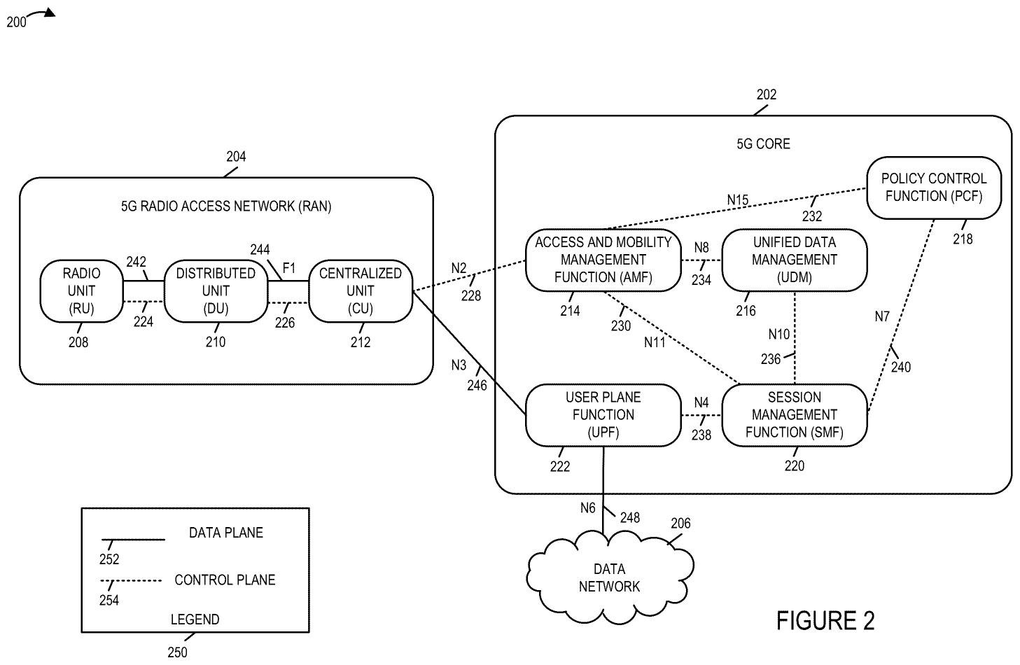

FIG. 2 is a drawing 200 illustrating exemplary components, connections and interfaces in an exemplary communications system including a 5G core network 202. The exemplary communications system includes a 5G radio access network (RAN) 204, a 5G core 202, and a data network (DN) 206 coupled together as shown. Legend 250 indicates that a solid line (such as solid line 252) is used to indicate data plane. Legend 250 further indicates that a dotted line (such as dotted line 254) is used to indicate control plane. 5G RAN 204 includes a radio unit (RU) 208, a distributed unit (DU) 210 and a centralized unit (CU) 212) coupled together as shown. The 5G core 202 includes an access and mobility management (AMF) function 214, a unified data management (UDM) 216, a policy control function (PCF) 218, a session management function (SMF) 220 and a user plane function (UPF) 222 coupled together as shown.

Control plane connection 224 couples the RU 208 to the DU 210. Control plane connection 226 coupled the DU 210 to the CU 212. N2 interface control plane connection 228 couples the CU 212 to the AMF 214. N15 interface control plane connection 232 couples the AMF 214 to the PCF 218. N8 interface control plane connection 234 couples the AMF 214 to UDM 216. N11 interface control plane connection 230 coupes the AMF 214 to the SMF 220. N10 interface control plane connection 236 couples the UDM 216 to the SMF 220. N7 interface control plane connection 240 couples the PCF 218 to the SMF 220. N4 interface control plane connection 238 couples the SMF 220 to the UPF 222.

Data plane connection 242 couples the RU 208 to the DU 210. Data plane FI connection 244 couples the UD 210 to the CU 212. N3 interface data plane connection 246 couples the CU 212 to the UPF 222. N6 interface data plane connection 248 couples the UPF 222 to the data network 206.

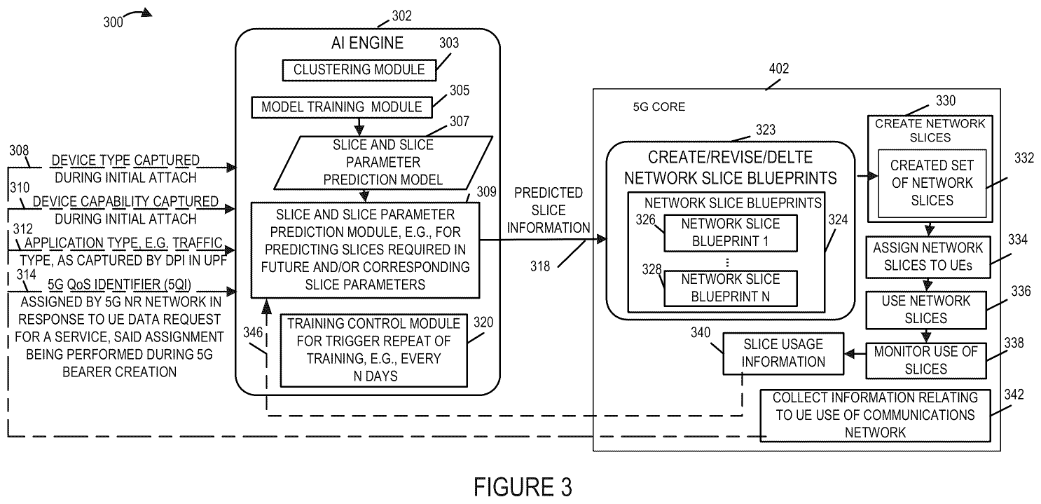

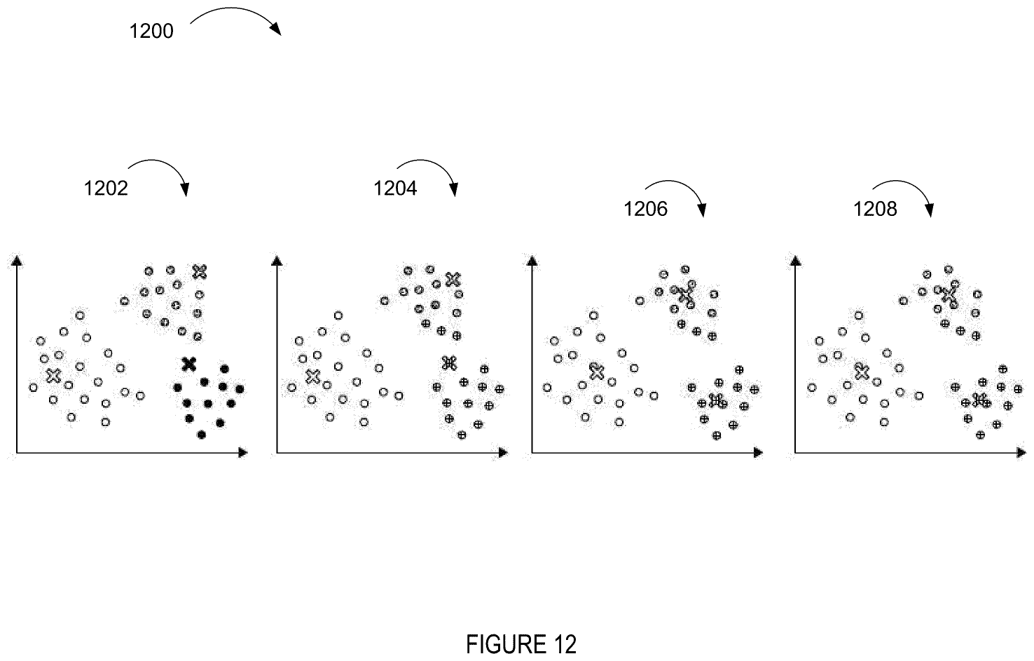

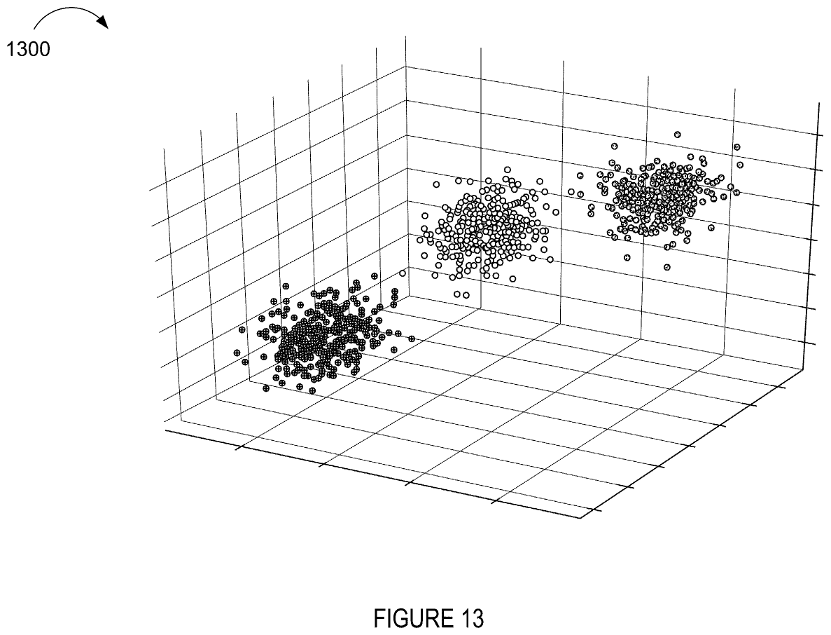

FIG. 3 is a drawing 300 which shows various system components at a high level, such as an AI Engine 302 and 5G core 402. FIG. 3 includes functional representations of inputs, outputs, and operations performed in accordance with the present invention, e.g., to generate a set of network slices and for collecting and using information to train and/or refine a slice and slice parameter prediction module 307 used to predict the network slices and corresponding network slice parameters which will be required to support network operations. Network slice blueprints 323 (network slice blueprint 1 326, . . . , network slice blueprint N 328) are used, e.g., by an OSS, (which has knowledge of the network resources which are available to be allocated) to create/implement network slices (sometimes referred to as network slice instances). The AI engine 302 can be and sometimes is implemented using a processor and memory. The processor controls the AI engine 302 to perform clustering, model training, and to make slice and parameter predictions under the direction of (e.g., in the case of software modules) or under the control of (e.g., in the case of hardware modules). Clustering module 303, model training module 305, slice and slice parameter prediction module 309 and model training control module 320 are implemented as part of the AI engine in some embodiments. In the case of software module implementations, the modules are stored in memory until executed by the processor of the AI engine at which time the computer executable instructions in the module control the processor to control the AI to perform the steps or operations described as corresponding to the module. For example, clustering module 303 performs data clustering on collected data to provide data insights into the type of network slice blueprints that may be desired or required, e.g., for an initial period of time prior to training and use of the slice and slice parameter prediction model 307 which is used to predict network slice and slice parameter requirements during other time periods. Training control module 320 controls initial generation and training of the slice and slice parameter prediction module and subsequent retraining of the model 307 at various intervals, e.g., periodic intervals in some cases and at non-periodic intervals in other cases, e.g., in response to detecting a change in the type of traffic being handled by the network or the relative amounts of traffic of different types passing through the network. The clustering performed by module 303 may be one of a variety of different types of clustering, e.g., K-means clustering such as shown in FIG. 12 or Tee Chart clustering as shown in FIG. 13. The clustering can be performed on network information collected prior to use of the slice and slice parameter prediction model 307 to control slice creation. Clustering, implemented by the AI module as a form of unstructured machine learning, can and sometimes does provide useful insights into what network slice blueprints should be created/used as a default set of network slice blueprints that can serve as a staring point for subsequent refinement and resource allocation based on predicted network slice needs.

While the AI engine 302 is shown external to the 5G Core 402 it can be and sometimes is implemented as part of the 5G core. The AI engine 302 controls, in some cases, the collection of data used for slice and slice parameter prediction model training and/or or clustering and receives such network information from the 5G core 402. The information received from the 5G core includes, in some embodiments, one or more of UE device type information 308 that is captured during UE initial attach operations, UE device capability information 310 that is captured during a UE attach operation, application type information 312, e.g., information determined based on the type of traffic UE data corresponds to as captured using deep packet inspection performed by a UPF of the 5G core 402, and Quality of Service (QOS) information 314 corresponding to a UE such as 5G QoS identifier information such as 5QI information assigned during bearer creation for a UE. During model training performed by module 305, information 346 relating to actual slice usage during a period of time is monitored and reported to the AI engine so that for training purposes, the AI engine can treat the UE related information 308, 310, 312, 314 as inputs with the actual slice utilization information indicating the slice or slices used by UEs as a corresponding known output during training of the slice and slice parameter prediction model 307.

After model training, when using the slice and slice parameter model 307 to predict network slices required for a future time period, device type, device capability, traffic type, QoS information corresponding to UEs using the network can be used as inputs with the model 307 being used to predict what network slices will be required during an upcoming time period and the parameters that should be used for such models. The collected information used for predictions follows the model training procedure and can be saved, with actual slice utilization information, to be used for updating the model to increase the reliability of future predictions.

This predicted slice information 318 which is generated by the AI engine includes network slice information and corresponding network parameter information for each of the individual network slices for which information is provided. This information is used to revise or modify network slice blueprints and/or create new network slice blueprints matching the network slices and slice parameters indicated in information 318.

A network slice blueprint includes specifications, e.g., requirements, for a network slice. For example, a network slice blueprint includes information identifying NFs (with resource requirements), overall resource allocation information for the slice, service level agreement information (e.g., latency, throughput, and reliability information) corresponding to the slice and orchestration information, e.g., management information, corresponding to the slice. The system starts with default network slice blueprints, which are used to generate an initial set of network slice instances, said generating an initial set of network slice instances including assigning NFs with particular resource requirements to particular available compute nodes which can meet the requirements. The default network slice blueprints may be a set of blueprints that support slices which are identified by using the clustering module to cluster UE and/or slice utilization information, e.g., information collected from a network prior to use of the AI engine 302 to control network slice creation. The parameters initially used in the default slice blueprints can be selected to satisfy the needs of UEs which are clustered as a group and likely to use a specific one of the slices created from the default slice blueprints. Another slice blueprint can be created based on the features of another data cluster. In this way a default set of network slices can be created based on clustered information.

As the system operates, data to be used as input and/or training data for the AI Engine is collected, and then the collected data is fed to a clustering module 303 and/or a model training module 305 as part of a machine learning process. The clustering algorithm 303 is, in some embodiments, a K nearest neighbors (KNN) clustering algorithm that clusters data to provide useful insights, e.g., what slices are being used and the range of parameters for the slices but the clustering module may implement other clustering algorithms instead. Model training module 305 can train a slice and slice parameter prediction module 307 to make network slice and corresponding slice parameter predictions so that slice blueprints can be modified and slices generated therefrom to satisfy precited future network needs for network slices. SOME or all of data 308, 310, 312, 314 can be used for predictions while the actual slice utilization information 340 is normally used for training along with corresponding information 308, 310, 312, 314. Device type information 308 is captured during initial attach of a UE, device capability information 310 is captured during initial attach of a UE, application type information 312, e.g., traffic type, as captured in UPF via packet inspection (e.g., DPI of layer 7 (application layer)), while QoS information 31, e.g., one or more quality of service identifier values, e.g., a 5QI (5G QoS identifier) value are assigned to a QoS flow by the 5G network in response to a service request during initial attach. Slice utilization information 316 is captured as actual slices are used and thus often follows the creation of slices based on one or more model predictions when the utilization is tracking use of slices created based on model predictions.

The output from the AI engine 302 is predicted slice information 318, which is used to update the existing set of network slice blueprints, e.g., modify one or more existing network slice blueprints, create one or more new network slice blueprints, and/or deleting (or marking as inactive) an existing network slice blueprint. Thus, a new set of network slice blueprints is formed, from which network slice instances are created by the OSS. The creation of network slice instances can include modifying existing network slice instances, e.g., reallocating resource from one network slice to another network slice, e.g., to compensate for more UEs using a first type of network slice and less UEs using a second type of network slice. In one exemplary embodiment, the network slice blueprints are updated every N days, e.g., with a new set of network slice instances being implemented by the OSS based on the updated set of network slice instances but updating may occur at more frequent intervals, e.g., every few minutes or on an hourly basis.

As part of the FIG. 3 process, slice information 318 generated by the AI engine 302 is received by the network slice blueprint creation/revision/deletion module 323 which creates, modifies or deletes one or more slice blueprints in the network slice blueprint store 324 so that there are blueprints for the network slices the information 318 predicts will be required to support network use. The information 318 in addition to listing one or more different types of network slices includes the parameters predicted to be required for each of the predicted network slices. Thus, for each predicted network slice there are corresponding predicted slice parameters. These parameters are used to populate the parameters of the blueprint being created for the identified network slice.

The predicted parameters in some embodiments include one or more of: a node type parameter indicating a type of node required to implement a predicted network slice, a resource allocation parameter (e.g., a parameter used to indicate bandwidth, compute resources and/or storage capacity required for a slice or node associated with the slice), a service level agreement parameter (e.g., a parameter which is to be satisfied by the slice such as a parameter indicating a latency requirement, a throughput requirement or a reliability requirement), a service requirement parameter indicating a service type to be supported or a parameter indicating a function type to be implemented.

From the blueprint creation/modification/deletion step corresponding to module 323, operation proceeds to step 330 in which network slices corresponding to the blueprints 304 are automatically created, e.g., by the OSS in the 5G core 402. In this way network slices are created in accordance with the predictions made by the AI engine 302. The network slices are assigned in step 334 to individual UEs, e.g., to support communications services. In step 336 multiple UEs can be assigned to and share a network slice with each UE being assigned what is sometimes referred to as a sub-slice or a UE slice. Thus, while a single UE might use an entire network slice in many cases UEs will share a network slice.

In step 336 the assigned network slices are used by the network to support UE services including various communications operations. In step 338 slice usage is monitored. Thus, in step 338 use of sub-slices corresponding to a network slice by one or more UEs is monitored thereby providing an indication of actual network slice usage. The time of usage by UEs is monitored as part of the monitoring step 338 along with UE identifiers allowing use by individual UEs to be associated with attach messages/device capability information/QoS information, and/or other information which is also captured by the 5G CORE along with time of capture information. Slice usage information 340 is communicated to the model training module as is UE related information 308, 310, 312, 314 to be used for model training/updating.

The slice and slice parameter prediction module 309 normally uses information 308, 310, 312 and/or 314 for making predictions with the corresponding slice usage information relating to the slices generated based on predictions being captured after the slices are created in accordance with the predictions.

Predictions are normally made by the slice and slice parameter prediction module 309 at a rate which is more frequent than the rate at which the slice and slice parameter prediction module is retrained/updated. This is so that the network slices available at a given time will be likely to be those required for a given time period and also to allow for the collection of slice utilization information over a longer period of time so that model training/updating can be performed based on a reasonably large known training data set collected over multiple days or even weeks to reduce the risk that unusual short term changes in network utilization will throw off the prediction model 307 in a significant way.

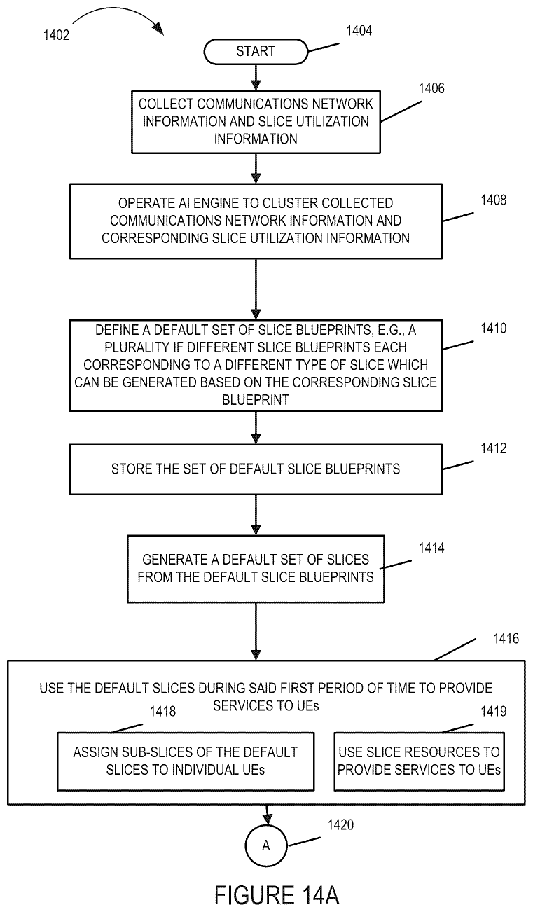

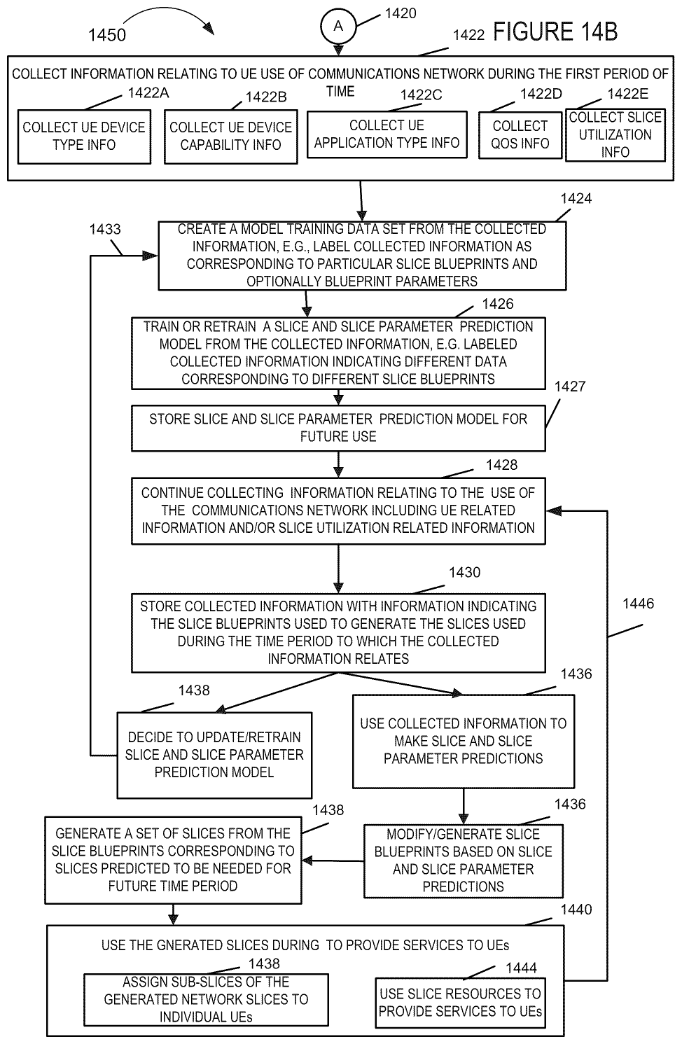

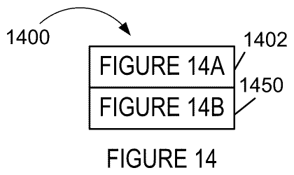

While the use of the AI engine in automatic slice generation has been discussed at a high level with regard to FIG. 3, the process is discussed in greater detail with regard to the flow chart of FIG. 14 which is discussed below following a discussion of various other figures.

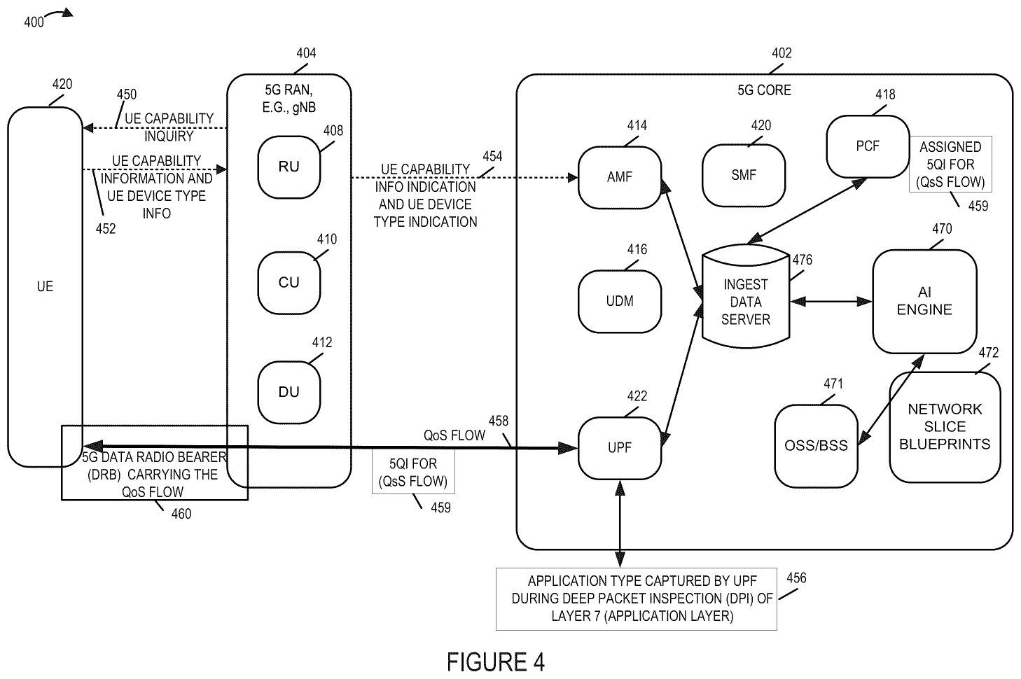

FIG. 4 is a drawing 400 illustrating exemplary architecture, exemplary data capture and an AI engine producing Network Slice Blueprints. Drawing 400 includes an exemplary UE 420 coupled to an exemplary 5G RAN 404, e.g., a gNB, which is coupled to an exemplary 5G core 402. The 5G RAN 404 includes a radio unit (RU) 408, a centralized unit (CU) 410 and a distributed unit (412). The 5G core 402 includes an AMF 414, a UDM 416, a PCF 418, a SMF 420, a UPF 422, an A/I engine 470, an OSS/BSS 471, and an ingest data server 476.

Data captured for dynamic network slicing comes from three different sources. A first source of data will now be described. During initial attach of UE 420, the 5G RAN 404 generates and sends a UE capability inquiry 450 (e.g., a UE Capability Inquiry Message) to UE 420. UE 420 receives the UE capability inquiry 450, and in response, generates and sends UE capability information and UE device type information 452 (e.g., a UE Capability Information Message) to the 5G RAN 404, which forwards the received information as UE capability information indication and UE device type information 454 (e.g., a NGAP UE Capability Info Indication Message) to AMF 414, which communicates the information to ingest data server 476.

A second source of data will now be described. In response to a received service request from the UE 420, the 5G network 402, e.g., the PCF 418, assigns a 5G Quality indicator (5QI) value 459 for a QoS flow 458 corresponding to the service request. The QoS flow 448, having the assigned 5QI 459, is mapped to a 5G data radio bearer (DRB) which will carry the QoS flow 458 between the RAN 404 and the UE 420. Thus, in response to the service request from the UE 420, a bearer request happens and 5QI is assigned. When the 5QI is assigned to a QoS flow, in response to a received service request, the assigned 5QI is also stored in the ingest data server 476.

A third source of data will now be described. Application type 456 is captured by UPF 422 via (data plane) packet inspection (deep packet inspection (DPI) of layer 7 (application layer)), as indicated by bi-directional arrow. The captured application type information 456 is communicated to the ingest data server 476.

The ingest data server 476 ingests data from all three sources and provides the information to the AI engine 470. The ingest data server 476, in some embodiments, also saves the ingested data, e.g., to be available in the future as historical data.

The AI engine 470 runs a clustering algorithm to create/edit network slices via network slice blueprint. Network slice blueprints 472, e.g., an updated set of network slice blueprints, is sent to the OSS/BSS 471 for implementation.

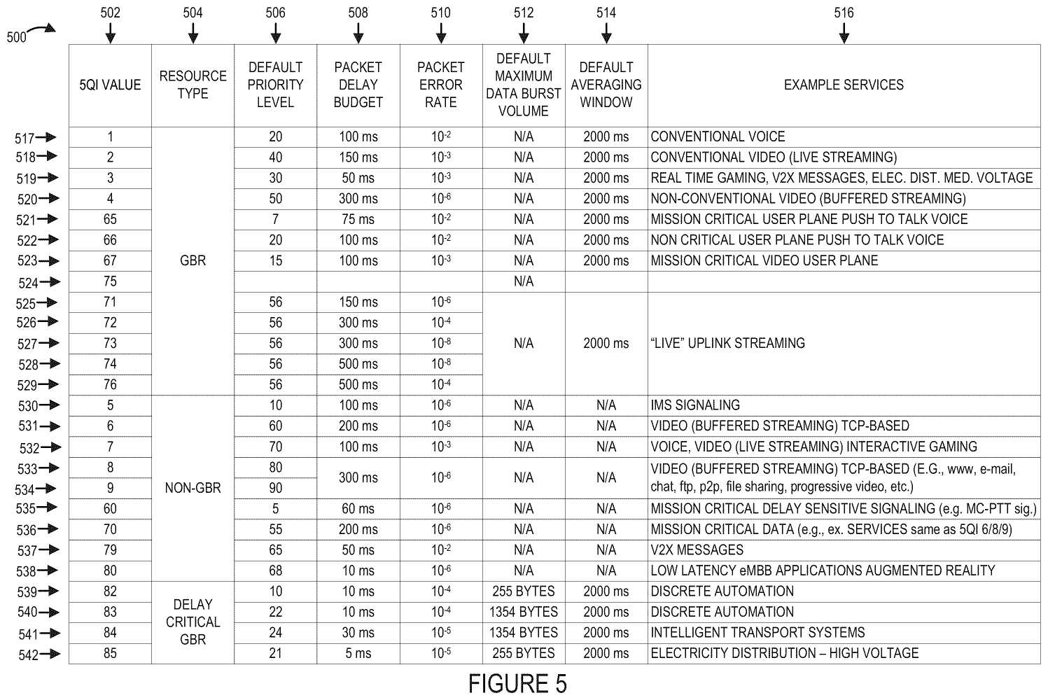

FIG. 5 is a 5G Quality of Service Indicator (5QI) table 500 which lists QoS characteristics in 5G for a plurality of different 5QI values. 5GQI is similar to QCI in LTE. When a 5G device makes a data request for any type(s) of service, the 5G network automatically assigns identifier: 5QI for each user service with the required QoS and creates a bearer. For example, there are different 5QI for voice call, video call or live stream.

The 5QI table 500 illustrates mapping of 5QI values to resource type, default priority level, packet delay budget, packet error rate, default maximum data burst volume, default average window, and example services. First column 502 includes 5QI value information. Different 5QI values map to different sets of quality of service characteristics. Second column 504 includes resource type information. Resource type information, for a particular 5QI value, is one of: GBR (Guaranteed Bit Rate), non-GBR, or delay critical GBR. Third column 506 includes default priority level information. The default priority level, for a particular 5QI value, is an integer value. A lower priority level number implies higher priority. Fourth column 508 includes packet delay budget information. The packet delay budget (PDB) indicates an upper bound for the time that a packet may be delayed between the UE and the N6 termination point at the UPF. Fifth column 510 includes packet error rate information. Sixth column 512 includes default maximum data burst volume information. Seventh column 514 includes default averaging window information. Eight column 516 includes example services. Rows (517, 518, 519 520, 521, 522, 523, 524, 525, 526, 527, 528, 526, 527, 528, 529, 530, 531, 532, 533, 534, 535, 536, 537, 538, 539, 540, 541, 542) corresponding to 5QI values (1, 2, 3, 4, 65, 66, 67, 75, 71, 72, 73, 74, 76, 5, 6, 7, 8, 9, 60, 70, 79, 80, 82, 83, 84, 85), respectively, and each row includes QoS characteristic information corresponding to the 5QI value indicated in the row.

As one example, consider row third 519; the 5QI value is 3; the resource type is GBR; the default priority level is 30; the packet delay budget is 50 ms; the packet error rate is 10-3; the default maximum data burst window is not applicable (N/A); the default averaging window is 2000 ms; and the example services include: real time gaming, V2X messages, electrical distribution medium voltage, and process automation managing.

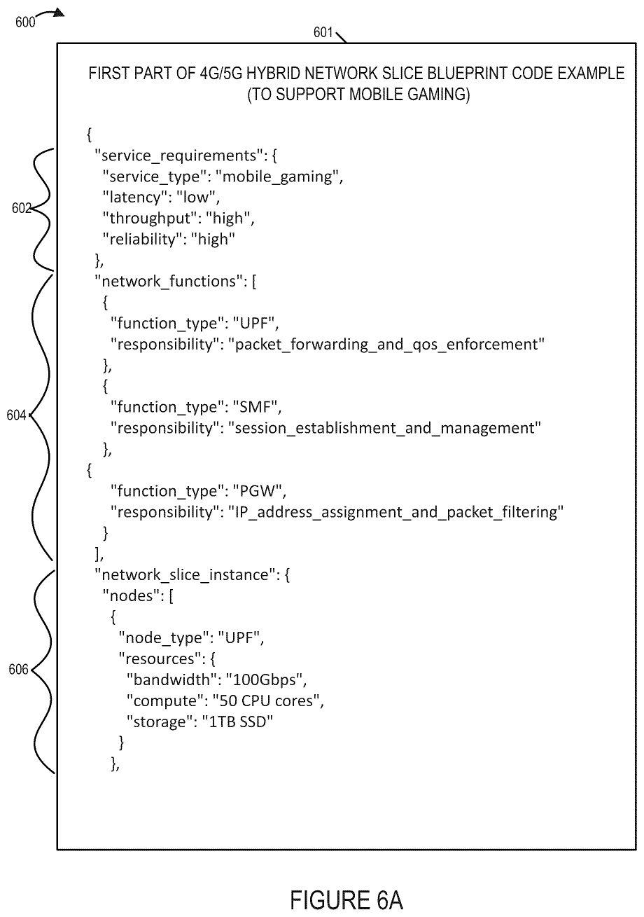

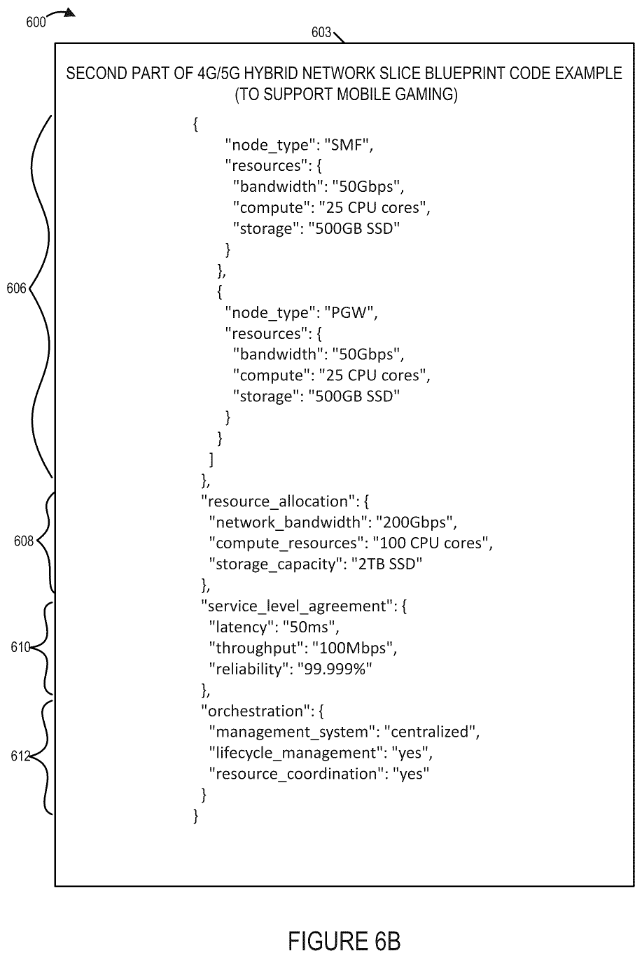

FIG. 6, comprising the combination of FIG. 6A and FIG. 6B, illustrates an exemplary network slice blueprint code example 600 to support mobile gaming. Network slice blueprint example 600, comprising the combination of first part 601 and second part 603, includes service requirement information 602 which specify service type=mobile gaming, latency=low, throughput=high, and reliability=high. Network slice blueprint example 600, further includes network function information 604 specifying NFs (UPF, SMF, and PGW) which are to be included as part of the network slice and the responsibilities of each NF, which are to be included as part of the network slice. Network slice blueprint example 600 further includes network slice instance information 606 specifying nodes in the network slice instance and resources for each node. The UPF type node requires the following resource allocation: bandwidth=100 Gbps (throughput), compute=50 CPU cores, and storage=1 TB SSD. The SMF type node requires the following resource allocation: bandwidth=50 Gbps (throughput), compute=25 CPU cores, and storage=500 GB SSD. The PGW type node requires the following resource allocation: bandwidth=50 Gbps (throughput), compute=25 CPU cores, and storage=500 GB SSD. Network slice blueprint example 600 further includes overall resource allocation information 608, which specifies network bandwidth=200 Gbps, compute resources=100 CPU cores, and storage capability=2 TB SSD. Network slice blueprint example 600, further includes service level agreement information 610 specifying latency: 50 ms, throughput 100 Mbps, and reliability: 99.999%. Network slice blueprint example 600, further includes orchestration information 612.

The service requirements of the network slice blueprint example 600 indicate that the network slice is designed to support a mobile gaming service with low latency, high throughput and high reliability. The network slice blueprint example 600 indicates that the network slice includes the following network functions: user plane function (UPF), which is responsible for packet forwarding and QoS enforcement, session management function (SMF), which is responsible for session establishment and management, and packet gateway function (PGW), which is responsible for IP address assignment and packet filtering. The network slice blueprint example 600 indicates that the network slice instance is instantiated on a set of network nodes that includes the UPF, SMF and PGW. The network slice is allocated resources based on the service requirements specified in the network slice blueprint (e.g., blueprint 600), said allocated resources including, e.g., network bandwidth, computing resources and storage capability. A service level agreement (SLA) is defined for the network slice and included in the network slice blueprint (e.g., blueprint 600), said SLA includes performance metrics such latency, throughput and reliability metrics. Orchestration information is included in the network slice blueprint (e.g., blueprint 600). The network slice is orchestrated through a centralized management system, which is responsible for managing the lifecycle of the network slice and coordination resources across different network node. Overall, the network slice blueprint 600 ensures that the mobile gaming service meets its performance requirements while sharing network resources with other services in a flexible and efficient manner.

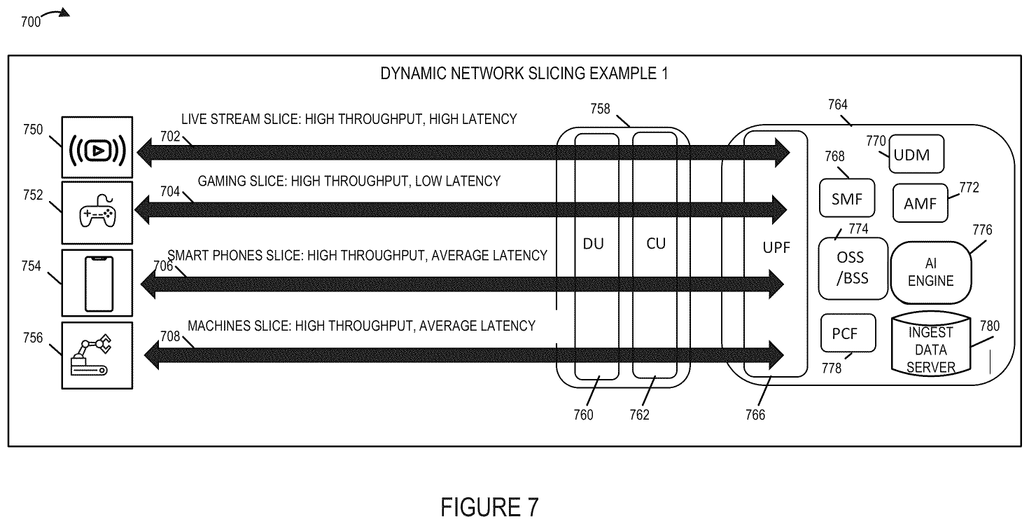

FIG. 7 includes drawing 700, which illustrates a first example of dynamic network slicing. Block 750 represents a set of UEs (e.g., PCs or laptops) which are each using a streaming application. Block 752 represents a set of UEs (e.g., gaming type devices) which are each using a gaming application. Block 754 represents a set of UEs (e.g., smart cell phones) which are each using a voice application. Block 756 represents a set of UEs (e.g., machine devices) which are each using a machine related control and/or monitoring application. Block 758 represents access networks, which each includes a distributed component 760 and a centralized component 762. Block 764 represents a 5G core which includes one or more instances of each of the following network functions (UPF 766, UDM 770, AMF 772, and PCF 778). The network functions can be and sometimes are implemented in nodes with each node including a processor and memory and with the processor being configured to control the node to perform the function or functions associated with the node. The functions in some embodiments are cloud based functions. The 5G core 764 further includes OSS/BSS 774, AI engine 776, and ingest data server 780.

In the example of FIG. 7, the network has 4 slices: live stream slice 702, gaming slice 704, smart phones slice 706, and machines slice 708. The live stream slice 702 is a high throughput, high latency slice. The live gaming slice 702 is a high throughput, low latency slice. The smart phones slice 706 is a high throughput, average latency slice. The machines slice 708 is a high throughput, average latency slice. In the example of FIG. 7, the four slices (live stream slice 702, gaming slice 704, smart phones slice 706, and machines slice 708) equally utilize the 5G core resources.

Consider that the system of FIG. 7, implements a method in accordance with the present invention, e.g., ingested data (including device type and capability information, 5QIs, and application type information is collected and stored in ingest data server 780 during operation. It should be appreciated that the number of UEs using each slice may, and sometimes does, change over time. AI engine 776 implements a ML clustering algorithm, processes the ingested data, and determines that industrial machines are not being used and more industrial gamers are on the network. The AI engine 766 deletes the machines slice 708 and increases the size of the gaming slice.

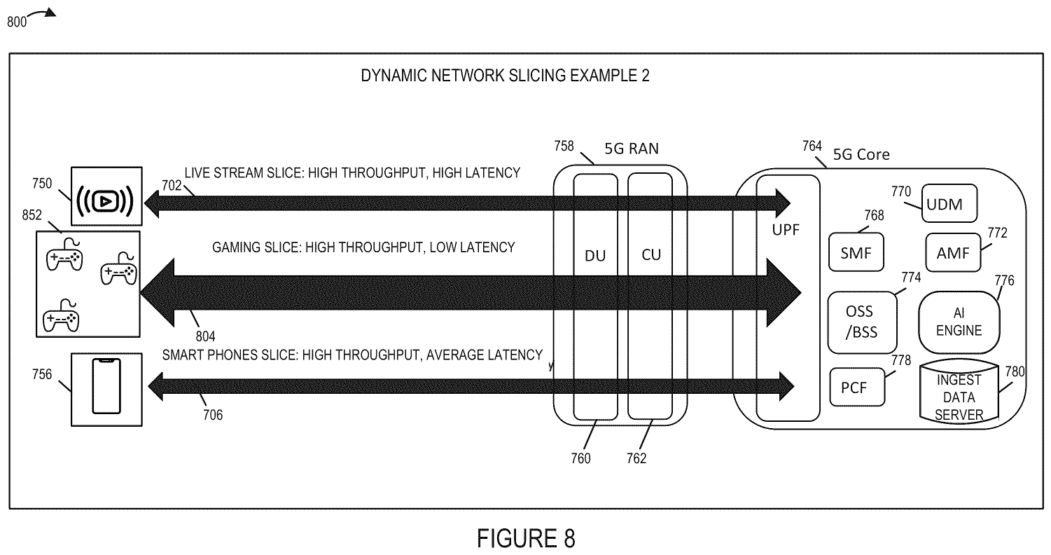

FIG. 8 includes drawing 800, which illustrates a second example of dynamic network slicing, represents a new set of slices from those of FIG. 7, said new set being implemented by the OSS of OSS/BSS 774 in response to information received from the AI engine 776, e.g., said information including a modified gaming slice blueprint indicating the allocation of additional resources to the gaming slice, and an indication that the instance of the machine slice 708 is to be deleted or resources for this slice are to be set to 0.

Block 852 represents an updated set of UEs (e.g., gaming type devices) which are each using a gaming application, said updated set of UEs being larger than the set of UE indicated by block 752 of FIG. 7. In the example of FIG. 8, the network has 3 slices: live stream slice 702, gaming slice 804, and smart phones slice 706. The live stream slice 702 is a high throughput, high latency slice. The live gaming slice 804 is a high throughput, low latency slice. The smart phones slice 706 is a high throughput, average latency slice.

Note that the size of gaming slice 804 of FIG. 8, is larger than (e.g., 2 times larger than) the size of gaming slice 704 of FIG. 7, as network resources previously allocated to machine slice 708 have been reallocated to be used for the new gaming slice 804.

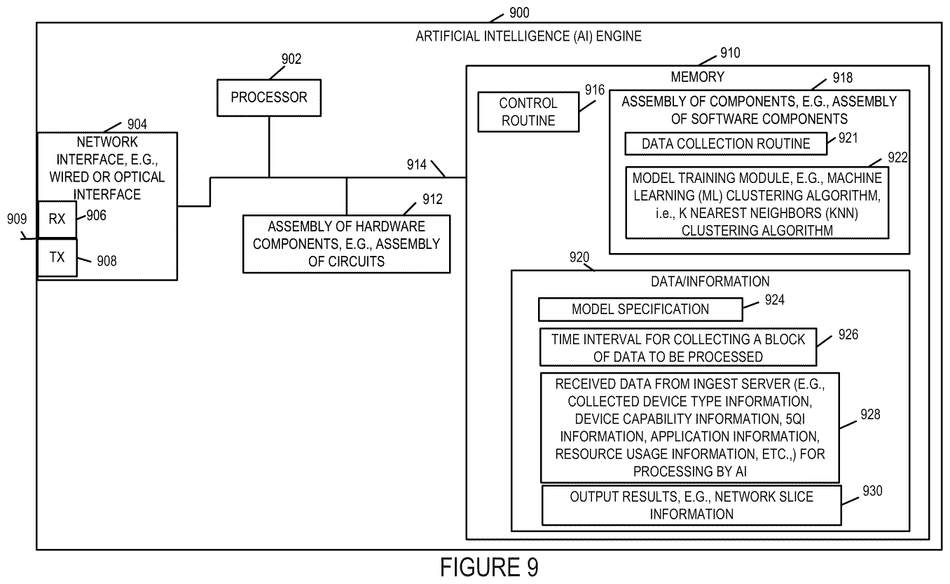

FIG. 9 is a drawing of an exemplary artificial intelligence (AI) engine 900 in accordance with an exemplary embodiment. AI engine 900 includes a processor 902, e.g., a network interface 904, e.g., a wired or optical interface, memory 910, and an assembly of hardware components 912, e.g., an assembly of circuits, coupled together via a bus 914 over which the various elements may interchange data and information.

Network interface 904, e.g., a wired or optical interface, includes a receiver (RX) 906, a transmitter 908, and a connector 909, via which the AI engine may receive and sends signals to other devices including, e.g., an ingest data server, and an OSS. Memory 910 includes a control routine 916 and an assembly of components 918, e.g., an assembly of software components. Control routines include machine readable instructions, which when executed by processor 902, control the AI engine to perform basic operational functions such as operate interface 904, access memory, store in memory, etc. Assembly of components 918 includes a data collection routine 921 and a model training mode 922, e.g., a machine learning (ML) clustering algorithm, i.e., a K nearest neighbors (KNN) clustering algorithm. Data collection routine 921 includes machine executable instruction, which when executed by processor 902, control the AI engine 900 to retrieve data, e.g., device type info, device capability info, 5QI values, and application type information, which was previously collected and stored in the ingest data server, from the ingest data server. Model training module 922 includes machine executable instruction, which when executed by processor 902, control the AI engine 900 to process received input data and determine AI prediction based network slice update information, e.g. to modify existing network slice blueprints (e.g., different resource allocations), to generate new network slice blueprints, and/or to delete or classify as inactive existing network slice blueprint(s) (e.g., due to detected inactivity), and to communicate network slice blueprint information (e.g., modification information and/or complete blueprints) to an OSS for implementation, e.g. to modify an existing network slice instance, to generate a new network slice instance and/or to delete an existing network slice instance.

Data/information 920 includes a model specification 924 to be sued by the model training module 922, a time interval 926 for collecting a block of data to be processed and/or a time interval between when network slices are to be updated, received data 928 from the ingest server (e.g., collected device type information, collected device capability information, 5QI information, application information, resource usage information, etc.) for processing by AI, e.g., an output results, e.g. network slice information, e.g., a new set network slice blueprints to be implemented.

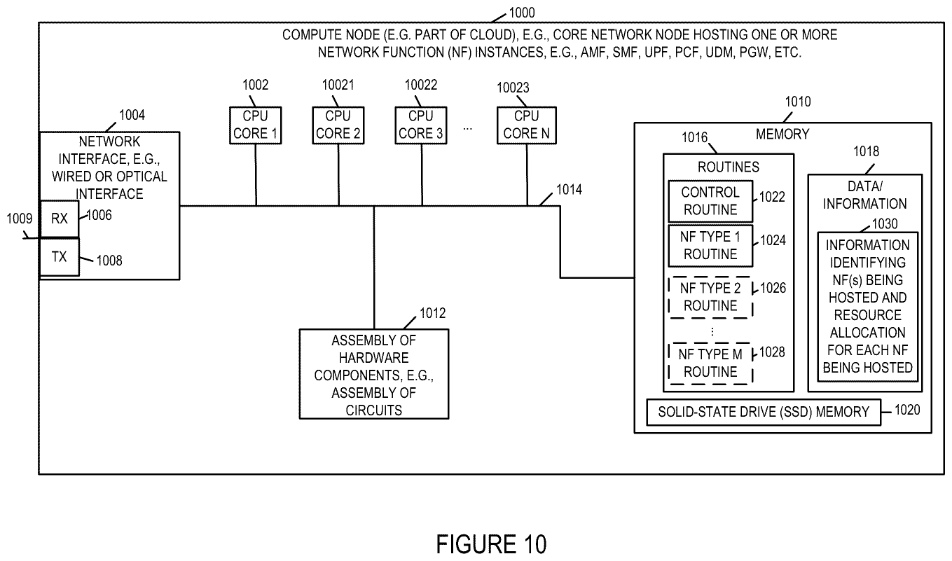

FIG. 10 is a drawing of an exemplary compute node 1000, e.g., a core network node hosting one or more network function (NF) instances, e.g., AMF, SMF, UPF, PCF, UDM, PGW, etc., in accordance with an exemplary embodiment. The compute node 1000 may be, and sometimes is, part of a cloud. Compute node 100 includes a plurality of CPU cores (CPU core 1 1002, CPU cored 2 10021, CPU core 3 10022, . . . , CPU core N 10023), a network interface 1004, memory 1010, and an assembly of hardware components 1012, e.g., an assembly of circuits, coupled together via a bus 1014 over which the various elements may interchange data and information.

Network interface 1004, e.g., a wired or optical interface, includes a receiver (RX) 1006, a transmitter 1008, and a connector 10009, via which the compute node 1000 may receive and sends signals to other devices including, e.g., an operation support system, other core network nodes, other compute nodes implementing NFs, a (R)AN, a data network, other devices and/or the Internet. Memory 1010 includes a routines 1016, data/information 1018 and solid-state drive (SSD) memory 1020. Routines 1016 includes a control routine 1022, a network function (NF) type 1 routine 1024, and in some embodiments, one or more additional NF type routines (NF type 2 routine 1026, . . . , NF type N routine 1028). For example, NF type 1 routine 1024 is a UPF routine, NF type 2 routine 1026 is a SMF routine, and NF type N routine is an AMF routine. Control routine 1022 includes machine readable instructions, which when executed by one or more processors, e.g., one or more of CPU core 1 1002, CPU core 2 10021, CPU core 3 10022, . . . , CPU core N 10023), control the compute node to perform basic operational functions such as operate interface 1004, access memory, store in memory, etc. Each NF type routine (NF type 1 routine 1024, NF type 2 routine 1026, . . . , NF type N routine 1028), includes machine readable instructions, which when executed by one or more processors, e.g., one or more of CPU core 1 1002, CPU core 2 10021, CPU core 3 10022, . . . , CPU core N 10023) which have been allocated to implement the NF, control the compute node to perform the operations pertaining to the NF to which it has been assigned. For example a first set of CPU cores may have been allocated to implement a UPF instance, and a second set of CPU cores may have been allocated to implement a SMF instance. Cores of compute node 1000 may be, in some embodiments, allocated to implement only one NF type, e.g., with the compute node being consider a specific type of NF node, e.g., UPF node. Compute node 1000 may be, and sometimes is, used to implement multiple instances of the same type of NF, e.g., multiple instances of a UPF with different instances corresponding to different slices.

Data/information 1018 includes information identifying NF(s) being hosted and resource allocation information for NF(s) being hosted, e.g., including SSD allocations, CPU core allocations, and throughput allocations. Solid state drive memory (SSD) memory includes blocks of memory which may be and sometimes are allocated to particular NF(s) being hosted on the compute node 1000 in accordance with resource allocation information communicated from the OSS to the compute node.

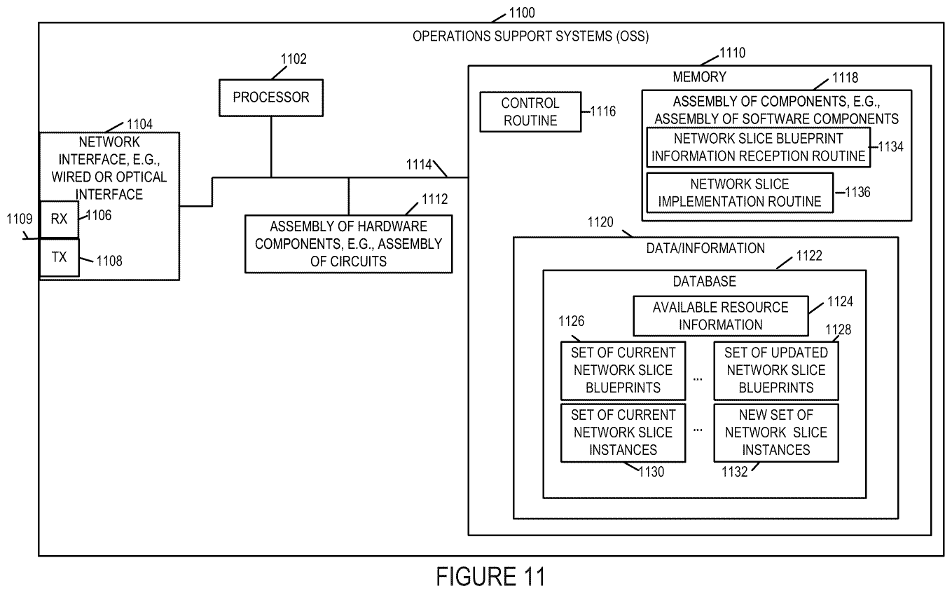

FIG. 11 is a drawing of an exemplary operations support systems (OSS) 1100 in accordance with an exemplary embodiment. OSS 1100 includes a processor 1102, e.g., a CPU, network interface 1104, e.g., a wired or optical interface, memory 1110, and an assembly of hardware components 1112, e.g., an assembly of circuits, coupled together via a bus 1114 over which the various elements may interchange data and information.

Network interface 1104, e.g., a wired or optical interface, includes a receiver (RX) 1106, a transmitter 1108, and a connector 1109, via which the OSS 1100 may receive and sends signals to other devices including, e.g., an AI engine, NF nodes, compute nodes hosting NFs, a BSS, various databases, other network nodes, and/or the Internet. Memory 1110 includes a control routine 916 and an assembly of components 1118, e.g., an assembly of software components. Control routine 1116 includes machine readable instructions, which when executed by processor 1102, control the OSS to perform basic operational functions such as operate interface 1104, access memory, store in memory, etc. Assembly of components 1118 includes a network slice blueprint information reception routine 1134, and a network slice implementation routine 1136. Network slice blueprint information reception routine 1134 includes machine readable instructions, which when executed by processor 1102, control the OSS 1100 receive network slice blueprints, network slice blueprint update information, network slice blueprint deletion information, and/or other network slice blueprint related information from the AI engine. Network slice implementation routine 1136 includes machine readable instructions, which when executed by processor 1102, control the OSS 1100 to implement, modify, maintain and/or delete one or more network slice instances in accordance with network slice blueprints, said implementation including selecting compute nodes to host NFs, and communicating resource allocation information to selected compute nodes.

Data/information 1120 includes database 1122, which includes available resource information 1124, a set of current network slice blueprints 1126, a set of current network slice instances 1130, a set of updated network slice blueprints 1128 (e.g., received from the AI engine or generated based on modification information (e.g., resource re-allocation information) received from the AI engine) and a new set of network slice instances 1132.

FIG. 12 illustrates use of K-means clustering which is used in some embodiments. Diagram 1200, s a series of clustering diagrams 1202, 1204, 1206, 1206, that show K-means clustering which is a known clustering technique used in some embodiments of the invention. Diagram 1202 shows random positioning of cluster focal points which are represented in the figure by Xs. Diagram 1204 shows assignment of the point to the cluster center of gravity, represented by an X. Diagram 1206 shows the result of calculating new cluster focal points from the points included in the cluster corresponding to the focal point. As part of L-means clustering assignment of the points in the cluster center of gravity which is closest and calculation of the new cluster focal points from the points in the corresponding cluster will continue until the cluster no longer changes with the clusters becoming stable and with the assignment of the points being to the cluster center of gravity which is closest as represented in diagram 1208.

FIG. 13 illustrates a second clustering technique, TeeChart that is used in some embodiments. In the FIG. 13 example, data is clustered into three clusters which are shown in a 3-D space.

The use of AI machine learning and an AI engine 170 or 302 to predict network slice needs and parameters in an automated manner as part of the process of automatically generating and using slices in a communications network will now be described in detail with reference to the steps shown in FIGS. 14A and 14B.

The method 1400 of FIG. 1400 begins in start step 1404 with the network being powered on and proceeding to support UE communications. In step 1406 communications network and slice utilization information is collected. The communications network information may and sometimes does include the information discussed with regard to FIG. 3, e.g., device type information captured during a UE's initial attach to the network, device capability information 310 captured during a UE's initial attach procedure, application type information 312 and QoS information 314, e.g., one or more QoS identifiers such as 5QI identifiers relating to a UE data request for service in which bearer creation is involved. The slice utilization information relates to UE use of existing network slices to receive services and may include information on the use of one or more sub-slices used by different UEs.

In step 1408 the AI engine is used to cluster the communications network information and slice utilization information to provide insights into the type of network slices being used and the parameters associated with such network slices.

In step 1410 a default set of network slice blueprints is defined, that is, generated, e.g., based on the clustered information. The default set of network slice blueprints includes a slice blueprint for each type of network slice the clustering indicates are normally required with parameters being set to allocate sufficient resources to satisfy what is expected to be normal traffic. The initial allocation of resources maybe uniform between slices of different types, e.g., with network resources being allocated evenly at first between the different default slices in accordance with the default blue prints but this is not the case in all embodiments. The slice blueprint generation is performed in some embodiments by a network slice blueprint generation module 323 in the network core 402.

The default set of slice blueprints is stored in memory, e.g., memory 324 in the network core, in step 1412 and then the slices in the set of default slice blueprints is generated in step 1414, e.g., by a call to the OSS of the 5G core. The default network slices are then used by the network core in step 1416 during a first period of time to provide services to UEs, e.g., network communications services. In some embodiments step 1416 includes assigning 1418 sub-slices of one or more default network slices to UEs and using the 1419 the assigned network slices or sub-slices corresponding to a network slice to provide services to the UEs. Operation proceeds from step 1416 to step 1422 via connecting node 1420. In step 1422 information is collected relating to UE use of the communications network during the first period of time. The information can be collected by various devices and at various locations in the network core 402 but is received and stored by the AI engine 302 and thus the AI engine 302 can be interpreted as collecting the information from the various components in the 5G core.

The collecting of information by the AI engine in step 1422 includes collecting of device type information 308, device capability information 310, application type information 312 and QoS information 314 in addition to actual slice utilization information 340. This information can be and sometimes is collected from devices such as the UPF in the network core which collect the information from various signals, messages or by deep packet inspection and/or the OSS which has information about network slice utilization by UEs. Thus, both UE related information corresponding to the request for resource and the corresponding actual slice utilization of network slices after resources are granted to UEs is collected by the AI engine 302 and/or network core 402 in a way that allows the information to be correlated and labeled for network slice and slice parameter model training purposes. In some embodiments step 1422 includes step 1422A which involves collecting UE device type information, substep 1422B which involves collecting UE device capability information, step 1422C which involves collecting UE application type information, step 1422D which involves collecting QoS information and step 1422E which involves collecting network slice utilization information.

In step 1424 a model training data set is generated from the information collected information with UE related information being labeled as training input data and information about the network slices being used as known outputs corresponding to the input data which relates to the UE signals, requests and data communication which resulted in the identified network slice usage.

In step 1426 the slice and slice parameter prediction model 307 is trained or retrained using, as model training data, the training data set generated in step 1424 and, in some cases, previously collected data. In some cases, steps 1424 and 1426 are implemented by the model training module 305 of the AI engine 302.

In some embodiments training of the slice and slice parameter prediction model (307) performed in step 1426 includes using labeled collected information corresponding to the first period of time as training data. In one such embodiment different sets of collected information corresponding to different network slices used during said first period of time are used as labeled training data to train the slice and slice prediction model (307), e.g., collected data corresponding to a live stream slice is labeled as corresponding to a live stream slice and used to train the model to predict the need for a live stream slice and the parameters which should be associated with the live stream slice; collected data corresponding to a gaming slice is labeled as corresponding to a gaming slice and used to train the model to predict the need for a gaming slice and the parameters which should be associated with the gaming slice; collected data corresponding to a smart phone slice is labeled as corresponding to a smart phone slice and used to train the model to predict the need for a smart phone slice and the parameters which should be associated with the smart phone slice; and collected data corresponding to a machine slice is labeled as corresponding to the machine slice and used to train the model to predict the need for a machine slice and the parameters which should be associated with the machine slice. In some embodiments collected slice resource utilization information (340) includes information which can be specified in a slice parameter, said information which can be specified in a slice parameter being used as a labeled parameter value corresponding to the particular network slice to which said information which can be specified in a slice parameter corresponds thereby providing labeled training data which can and is used in step 1426 in some embodiments to train the model to predict parameter values corresponding to slices which are predicted to be used.

In step 1427 the trained slice and slice prediction model 307 is stored in memory, e.g., in the AI engine 302 for future use in making predictions and possible retraining. With a slice and slice parameter prediction model now available for making predictions, operation proceeds to step 1428 in which information relating to communications network use by UEs continues to be collected. Thus, in step 1428 information 308, 310, 312 and 314 is collected. This information can and sometimes is used to make slice and slice parameter predictions. In step 1428 slice utilization information 340 is also collected with this information relating to the use of existing network slices. The collection of the information 308, 310, 312, 314, 340 is performed on an ongoing basis in step 1428 as indicated by the “continue collecting information” language in this step and with arrow 1446 representing that this step will be performed even after network slices are generated or modified and then used.

In step 1430 collected information is stored. The stored information includes time information allowing the collected information from different sources to be correlated and with sufficient information to allow UE requests and network use to be correlated to actual detected use of the UE by one or more network slices.

Operation is shown proceeding from storage step 1430 to steps 1438 and step 1436. The progression to these steps may be asynchronous with the retraining path represented by step 1438 being performed normally at greater time intervals than the slice prediction path represented by step 1436.

In step 1438 the AI decision engine 302, and the training control module 320 in particular, decides that it is time to retrain the slice and slice parameter predication module. The retraining may be performed on a scheduled basis, e.g., with model retraining/updating occurring weekly or monthly based on information collected since the last training operation. Optionally previously collected data may also be used in the training process. Thus, after initial model training the prediction model 307 may be updated using training data which was collected over long periods of time. Operation is seen proceeding from step 1438 to step 1424 in which the collected information will be processed to form a labeled set of taring data which is then use din step 1426 to retrain the slice and slice parameter prediction model thereby updating the model based on recently collected information. Operation proceeds from step 1426 to storage step 1427 and then onward as previously discussed each time the slice and slice parameter prediction model 307 is trained or retrained.

As noted above, operation proceeds from step 1430 to step 1436 so that collected information can be used to make network slice and slice parameter predictions. In step 1436 the slice and slice parameter prediction model 307 is used by the AI engine to make a network slice prediction and to predict the parameters which should be used in generating the network slices predicted to be required for an upcoming time period.

In some embodiments the slice and slice parameter prediction model (307), in step 1436, automatically predicts network slices required for a future period of time along with corresponding slice parameters (e.g., node type parameters indicating the types of nodes required to implement the slice; resource allocation parameters, e.g., parameters used to indicate bandwidth, compute resources and/or storage capacity required for a slice; service level agreement parameters which are to be satisfied by the slices such as latency, throughput and/or reliability; service requirement parameters indicating service type to be supported; latency, throughput and/or reliability, parameters indicating network functions to be provided to support the slice including a parameter indicating a function type such as “SMF” or “UPF”; and parameters indicating requirements for each of nodes of particular function types to be implemented in the slice such as requirements for a SMF node including bandwidth, compute and/or storage required to implement the SMF and requirements for a UPF node including bandwidth, compute and storage required to implement the UPF). In this path, collected information 308, 310, 312, and/or 314 is used by the slice and slice parameter prediction model 307 to predict what network slices will be required in the upcoming time period and the parameters to be used in generating such slices. The use of slices by UEs generated based on the predictions and used to improve the model in subsequent retraining operations.

Step 1436 produces predicted slice information 318, previously discussed with regard to FIG. 3, which is communicated to the network slice blueprint control module 323 which then modifies, generates, or deletes slice blueprints based on the predicted slice information 318 in step 1436. In step 1426 network slice blueprints are modified, generated or deleted based on slice prediction information generated in step 1436. Then in step 1438 a set of slices is generated based on the slice blueprints produced based on the slice and slice parameter predictions made in step 1436. The network slices generated in step 1438 are used in step 1440 by the network core 402 to provide services to UEs. Step 1440 includes in some embodiments step 1438 which includes assigning sub-slices of the generated network slices to individual UEs and step 1444 which involves using slice resource to provide services to UEs. Operation is seen going from step 1440 to collecting step 1428 by arrow 1446 to show that network information will continue to be collected and stored with the prediction step 1436 being potentially implemented on a relatively frequent basis, e.g., hourly or daily, and often more frequently than retraining of the prediction model occurs.

Various aspects and/or features of some embodiments of the present invention are described below. Various embodiments are directed to methods and apparatus to orchestrate network slices, to create network slices, and to perform life cycle management with regard to network slices automatically, e.g., based on the traffic type on the network.

In various embodiments, logic is implemented to define network slices needed based on one or more of the below collected data:
devices types and capability during initial attach;
5G QoS Identifier (5QI) assigned; and
application type information obtained from packet inspection at UPF.

Device type is sent during initial attach to the network where a device has to announce its capabilities and category type as per 3GPP. 5QI is the Quality of Service (QOS) characteristics in 5G. 5QI is similar to QCI in LTE. When a 5G device makes a data request for any types of service, the 5G NR network automatically assigns identifier: 5QI for each user service with the required QoS and creates a bearer. For example, different 5QI values are assigned for voice call, video call, live stream.

Deep Packet Inspection (DPI) is a 5G UPF core functionality. DPI is the examination of layer 7 (application layer), which contains Uniform Resource Identifier (URI) information for example: DNS, HTTP, HTTPS, RTP, and RTSP URLs. This creates application awareness in the network in terms of the network operator knowing what applications are being used by users.

The decision to create slices will take into account, in some embodiments, one or more of:
i) device type (from initial attach);
ii) 5QI (from bearer used); and
iii) application type (from DPI).

The core network can, and in accordance with a feature of the present invention, does link the device type to 5QI to application used which will result in the knowledge of what each device is doing exactly. In some embodiments, a clustering algorithm is used to process this data to determine the slices needed.

Clustering a well-known unsupervised Machine Learning algorithm to determine data types. Based on the data collected from the network (device type, 5QI, application type) it is possible plot a 3D data map and use K Nearest Neighbors (KNN) ML clustering (or any other clustering algorithm) different types of traffic and slices needed. These slices will serve as the network slice blueprint which will be used to automatically instantiate these slices and assign devices to them. Since this process will be repeated regularly a network slice can increase or decrease according to the devices assigned to it which gives elasticity to the network slices. This elasticity will happen by increasing or decreasing the resources assigned to the slices in like UPF, SMF, etc.

In accordance with some embodiments of the present invention, this logic is included in the OSS-BSS of the network since its already connected to the 5G core and can easily consume the data needed to create the network slices blueprints.

Various embodiments, in accordance with the present invention, provide a simpler and more efficient automated method to create network slices instead of the current manual method. This new automated approach ensures the network slices are up to date and devices assigned the network slices properly, as the new devices get activated on the network. This new approach also adds elasticity to the network slices based on the devices assigned to them.

### Numbered List of Exemplary Method Embodiments

Method Embodiment 1. A communications method, the method comprising: collecting (1422) information (308, 310, 312, 314, 340) relating to UE use of a communications network during a first period of time; training (1426) a slice and slice parameter prediction model (307) using the information relating to UE use of the communications network during the first period of time; operating an artificial intelligence engine (202) to use the slice and slice parameter prediction model (307) to automatically predict (1436) slices and slice parameters (e.g., node type parameters indicating the types of nodes required to implement the slice; resource allocation parameters, e.g., parameters used to indicate bandwidth, compute resources and/or storage capacity required for a slice; service level agreement parameters which are to be satisfied by the slices such as latency, throughput and/or reliability; service requirement parameters indicating service type to be supported; latency, throughput and/or reliability, parameters indicating network functions to be provided to support the slice including a parameter indicating a function type such as “SMF” or “UPF”; and parameters indicating requirements for each of nodes of particular function types to be implemented in the slice such as requirements for a SMF node including bandwidth, compute and/or storage required to implement the SMF and requirements for a UPF node including bandwidth, compute and storage required to implement the UPF) corresponding to predicted slices which are required for a future period of time; and automatically generating (1438) network slices predicted to be required for the future period of time from slice blueprints to which the predicted slices correspond and the predicted slice parameters corresponding to predicted slices.

Method Embodiment 2. The method of Method Embodiment 1, wherein collecting information (1422) relating to UE use of the communications network during the first period of time includes: collecting (1422A and/or 1422B) UE device information (308 and/or 310) (e.g., device type (308) and/or device capability (310) information) corresponding to UEs accessing a communications network during a first period of time; collecting (1422C) UE application type information indicting the type or types of applications being used by UEs accessing the communications network during the first period of time; collecting (1422D) quality of service information (314) (e.g., 5G QoS identifier (5QI) values and/or 4G QoS Class Identifier (QoC) values) corresponding to the UEs accessing the communications network during the first period of time; and collecting (1422E) information on slice utilization (340) during said first period of time.

Method Embodiment 3. The method of Method Embodiment 2, wherein the collected information on slice utilization (340) includes information on which network slices were utilized.

Method Embodiment 4. The method of Method Embodiment 3, wherein the collected information on slice utilization includes information on the resources corresponding to each of the utilized slices which were used during said first period of time, different resources corresponding to different slice parameters.

Method Embodiment 5. The method of Method Embodiment 1, wherein training (1426) the slice and slice parameter prediction model (307) includes using collected information corresponding to the first period of time as training data, different sets of collected information corresponding to different network slices used during said first period of time being used as labeled training data to train the slice and slice prediction model (307) (e.g., collected data corresponding to a live stream slice is labeled as corresponding to a live stream slice and used to train the model to predict the need for a live stream slice and the parameters which should be associated with the live stream slice; collected data corresponding to a gaming slice is labeled as corresponding to a gaming slice and used to train the model to predict the need for a gaming slice and the parameters which should be associated with the gaming slice; collected data corresponding to a smart phone slice is labeled as corresponding to a smart phone slice and used to train the model to predict the need for a smart phone slice and the parameters which should be associated with the smart phone slice; and collected data corresponding to a machine slice is labeled as corresponding to the machine slice and used to train the model to predict the need for a machine slice and the parameters which should be associated with the machine slice).

Method Embodiment 6. The method of Method Embodiment 5, wherein collected slice resource utilization information (340) includes information which can be specified in a slice parameter, said information which can be specified in a slice parameter being used as a labeled parameter value corresponding to the particular network slice to which said information which can be specified in a slice parameter corresponds (thereby providing labeled training data which can be used to train the model to predict parameter values corresponding to slices which are predicted to be used).

Method Embodiment 7. The method of Method Embodiment 1, wherein automatically predicting (1436), using an artificial intelligence engine, a set of network slices which will be required during the future period of time includes predicting types of slices and slice parameters for one or more of the different predicted types of slices.

Method Embodiment 8. The method of Method Embodiment 7, wherein predicted slice parameters include one, more or all of: a node type parameter indicating a type of node required to implement the slice, a resource allocation parameter (e.g., a parameter used to indicate bandwidth, compute resources and/or storage capacity required for a slice or node associated with the slice), a service level agreement parameter (e.g., a parameter which is to be satisfied by the slice such as a parameter indicating a latency requirement, a throughput requirement or a reliability requirement), a service requirement parameter indicating a service type to be supported or a parameter indicating a function type to be implemented.

Method Embodiment 9. The method of Method Embodiment 1, further comprising: collecting (1406) communications network information and slice utilization information during an initial period of time; operating the artificial intelligence engine (302) to perform machine learning (e.g., unstructured machine learning) in the form of clustering (1408) to cluster the collected communications network information and corresponding slice utilization information corresponding to the initial period of time; defining (1410) a default set of slice blueprints (324); generating (1414) a default set of slices from the default set of slice blueprints (324); and using (1416) the default set of slices during said first period of time.

Method Embodiment 10. The method of Method Embodiment 9, wherein the default set of slices includes at least a first slice (702) of a first slice type corresponding to a first slice type blueprint, a second slice (704) of a second slice type corresponding to a second slice type blueprint, a third slice (706) of a third slice type corresponding to a third slice type blueprint and a fourth slice (708) of a fourth slice type corresponding to a fourth slice type blueprint.

Method Embodiment 11. The method of Method Embodiment 10, wherein operating an artificial intelligence engine (302) to use the slice and slice parameter prediction model (307) to automatically predict slices and slice parameters which are required for a future period of time includes: predicting fewer slices being required in the future period of time than are included in said default set of slices, said fewer slices including a first slice (702) of the first slice type, a second slice (804) of the second slice type, and a third slice (706) of the third slice type but not a slice of the fourth type slice.

Method Embodiment 12. The method of Method Embodiment 11, wherein automatically generating (1438) the network slices predicted to be required for the future period of time includes allocating at least some resources previously allocated to the fourth slice corresponding to the fourth slice type to one or more of the first, second and third slices of the first set of slices.

Method Embodiment 13. The method of Method Embodiment 12, wherein the default set of slices includes a first slice which is a live stream slice (702), a second slice (704) which is a gaming slice, a third slice (706) which is a smart phones slice and a fourth slice (708) which is a machines slice; and wherein the first set of slices generated for said future period of time includes a live stream slice (702), a gaming slice (804) and a smart phones slice (706), some network resources allocated to the machines slice (708) of the default set of slices being reallocated to one or more of the slices (e.g., to slice 804) in the first set of slices as part of automatically generating said first set of slices.

Method Embodiment 14. The method of Method Embodiment 13, wherein said some network resources reallocated to one or more slices includes a number of processors (e.g., number of CPU cores), an amount of bandwidth (throughput in bps), and an amount of storage (e.g., an amount of solid-state drive (SSD) memory).

### Numbered List of Exemplary System Embodiments

System Embodiment 1. A communications system, the system comprising: a network communications core (102) configured to collect (1422) information (308, 310, 312, 314, 340) relating to UE use of a communications network during a first period of time; and an artificial intelligence engine (302) including: a model training module (305) configured to train (1426) a slice and slice parameter prediction model (307) using collected information relating to UE use of the communications network during the first period of time; a slice and slice parameter prediction model (307) configured to automatically predict (1436) slices and slice parameters corresponding to predicted slices, which are required for a future period of time (e.g., node type parameters indicating the types of nodes required to implement the slice; resource allocation parameters, e.g., parameters used to indicate bandwidth, compute resources and/or storage capacity required for a slice; service level agreement parameters which are to be satisfied by the slices such as latency, throughput and/or reliability; service requirement parameters indicating service type to be supported; latency, throughput and/or reliability, parameters indicating network functions to be provided to support the slice including a parameter indicating a function type such as “SMF” or “UPF”; and parameters indicating requirements for each of nodes of particular function types to be implemented in the slice such as requirements for a SMF node (220) including bandwidth, compute and/or storage required to implement the SMF and requirements for a UPF node (422) including bandwidth, compute and storage required to implement the UPF); and an OSS (172) in said network communications core (102) configured to automatically generate (1438) network slices predicted to be required for the future period of time from slice blueprints to which the predicted slices correspond and the predicted slice parameters corresponding to predicted slices.

System Embodiment 2. The system of System Embodiment 1, wherein the network core (102) includes: an AMF (414) collecting (1422A and/or 1422B) UE device information (308 and/or 310) (e.g., device type (308) and/or device capability (310) information) corresponding to UEs accessing a communications network during a first period of time; a UPF (422) for collecting (1422C) UE application type information indicting the type or types of applications being used by UEs accessing the communications network during the first period of time and for collecting (1422D) quality of service information (314) (e.g., 5G QoS identifier (5QI) values and/or 4G QoS Class Identifier (QoC) values) corresponding to the UEs accessing the communications network during the first period of time.

System Embodiment 3. The system of System Embodiment 2, wherein the network core (102) further includes an OSS for capturing network slice utilization information (340).

System Embodiment 4. The method of System Embodiment 3, wherein the collected information on slice utilization includes information on the resources corresponding to each of the utilized slices which were used during said first period of time, different resources corresponding to different slice parameters.

System Embodiment 5. The system of System Embodiment 2, wherein the model training module (305) is configured to use collected information corresponding to the first period of time as training data, different sets of collected information corresponding to different network slices used during said first period of time being used as labeled training data to train the slice and slice prediction model (307) (e.g., collected data corresponding to a live stream slice is labeled as corresponding to a live stream slice and used to train the model to predict the need for a live stream slice and the parameters which should be associated with the live stream slice; collected data corresponding to a gaming slice is labeled as corresponding to a gaming slice and used to train the model to predict the need for a gaming slice and the parameters which should be associated with the gaming slice; collected data corresponding to a smart phone slice is labeled as corresponding to a smart phone slice and used to train the model to predict the need for a smart phone slice and the parameters which should be associated with the smart phone slice; and collected data corresponding to a machine slice is labeled as corresponding to the machine slice and used to train the model to predict the need for a machine slice and the parameters which should be associated with the machine slice).

System Embodiment 6. The system of System Embodiment 5, wherein collected slice resource utilization information (340) includes information which can be specified in a slice parameter, said information which can be specified in a slice parameter being used as a labeled parameter value corresponding to the particular network slice to which said information which can be specified in a slice parameter corresponds (thereby providing labeled training data which can be used to train the model to predict parameter values corresponding to slices which are predicted to be used).

System Embodiment 7. The system of System Embodiment 6, wherein predicted slice parameters include one, more or all of: a node type parameter indicating a type of node required to implement the slice, a resource allocation parameter (e.g., a parameter used to indicate bandwidth, compute resources and/or storage capacity required for a slice or node associated with the slice), a service level agreement parameter (e.g., a parameter which is to be satisfied by the slice such as a parameter indicating a latency requirement, a throughput requirement or a reliability requirement), a service requirement parameter indicating a service type to be supported or a parameter indicating a function type to be implemented.

The AI engine 302 can be implemented using software, hardware or a combination of software and hardware. In some embodiments the AI engine includes a processor with the various modules being stored in memory included in the AI engine and include processor executable instructions which, when executed by the processor of the AI engine, control the processor and/or AI engine to implement the steps of the invention. In other embodiments the modules in the AI engine are implemented as hardware modules. In some such cases the modules in the AI engine are implemented as circuits. The AI engine can be incorporated into the network core or external to the network core.

Some embodiments are directed to a computer program product comprising a computer-readable medium, e.g., a non-transitory computer-readable medium, comprising code for causing a computer, or multiple computers, to implement various functions, steps, acts and/or operations, e.g., one or more steps described above. In some embodiments the computer program produce includes machine executable instructions for controlling the processor of an AI engine to perform in the manner described herein.

Depending on the embodiment, the computer program product can, and sometimes does, include different code for each step to be performed. Thus, the computer program product may, and sometimes does, include code for each individual step of a method, e.g., a method of controlling a controller or node. The code may be in the form of machine, e.g., computer, executable instructions stored on a computer-readable medium, e.g., a non-transitory computer-readable medium, such as a RAM (Random Access Memory), ROM (Read Only Memory) or other type of storage device. In addition to being directed to a computer program product, some embodiments are directed to a processor configured to implement one or more of the various functions, steps, acts and/or operations of one or more methods described above. Accordingly, some embodiments are directed to a processor, e.g., CPU, configured to implement some or all of the steps of the methods described herein. The processor may be for use in, e.g., a Configuration Auditor and Configuration Enforcer (CACE) device, an operations support system (OSS) device, a secure shell file transfer protocol (SFTP) server, a core network node, a base station, a UE, an access point, a device including a AMF, a device including a UDM, a device including a SMF, a device including a PCF, a device including a UPF, a server, a device including a N3IWF, a device including a TNGF, a base station, e.g., a sector base station, such as gNB, ng-eNB, eNB, etc., supporting beamforming, a UE, a base station supporting massive MIMO such as a CBSD supporting massive MIMO, a network management node or device, a communications device such as a communications nodes such as e.g., a UE, an access point, a device including a AMF, a device including a UDM, a device including a SMF, a device including a PCF, a device including a UPF, a server, a device including a N3IWF, a device including a TNGF, an access point (AP), e.g., WiFi AP, a base station such as NRU gNB base station, etc., a user device such as a station (STA), e.g., WiFi STA, a user equipment (UE) device, a LTE LAA device, etc., an RLAN device, a network communications device such as router, switch, etc., administrator device, MNVO base station, e.g., a CBSD, an MNO cellular base station, e.g., an eNB or a gNB, a UE device or other device described in the present application. In some embodiments, components are implemented as hardware devices in such embodiments the components are hardware components. In other embodiments components may be implemented as software, e.g., a set of processor or computer executable instructions. Depending on the embodiment the components may be all hardware components, all software components, a combination of hardware and/or software or in some embodiments some components are hardware components while other components are software components.

Numerous additional variations on the methods and apparatus of the various embodiments described above will be apparent to those skilled in the art in view of the above description. Such variations are to be considered within the scope. Numerous additional embodiments, within the scope of the present invention, will be apparent to those of ordinary skill in the art in view of the above description and the claims which follow. Such variations are to be considered within the scope of the invention.

What is claimed is:

1. A communications method, the method comprising:
collecting information relating to UE use of a communications network during a first period of time;
training a slice and slice parameter prediction model using the information relating to UE use of the communications network during the first period of time;
operating an artificial intelligence engine to use the slice and slice parameter prediction model to automatically predict slices and slice parameters corresponding to predicted slices which are required for a future period of time; and
automatically generating network slices predicted to be required for the future period of time from slice blueprints to which the predicted slices correspond and the predicted slice parameters corresponding to predicted slices.

2. The method of claim 1, wherein collecting information relating to UE use of the communications network during the first period of time includes:
collecting UE device information corresponding to UEs accessing a communications network during a first period of time;
collecting UE application type information indicting the type or types of applications being used by UEs accessing the communications network during the first period of time;
collecting quality of service information corresponding to the UEs accessing the communications network during the first period of time; and
collecting information on slice utilization during said first period of time.

3. The method of claim 2, wherein the collected information on slice utilization includes information on which network slices were utilized.

4. The method of claim 3, wherein the collected information on slice utilization includes information on the resources corresponding to each of the utilized slices which were used during said first period of time, different resources corresponding to different slice parameters.

5. The method of claim 1, wherein training the slice and slice parameter prediction model includes using collected information corresponding to the first period of time as training data, different sets of collected information corresponding to different network slices used during said first period of time being used as labeled training data to train the slice and slice prediction model.

6. The method of claim 5, wherein collected slice resource utilization information includes information which can be specified in a slice parameter, said information which can be specified in a slice parameter being used as a labeled parameter value corresponding to the particular network slice to which said information which can be specified in a slice parameter corresponds (thereby providing labeled training data which can be used to train the model to predict parameter values corresponding to slices which are predicted to be used).

7. The method of claim 1, wherein automatically predicting, using an artificial intelligence engine, a set of network slices which will be required during the future period of time includes predicting types of slices and slice parameters for one or more of the different predicted types of slices.

8. The method of claim 7, wherein predicted slice parameters include one, more or all of:
a node type parameter indicating a type of node required to implement the slice, a resource allocation parameter, a service level agreement parameter, a service requirement parameter indicating a service type to be supported or a parameter indicating a function type to be implemented.

9. The method of claim 1, further comprising:
collecting communications network information and slice utilization information during an initial period of time;
operating the artificial intelligence engine to perform machine learning in the form of clustering to cluster the collected communications network information and corresponding slice utilization information corresponding to the initial period of time;
defining a default set of slice blueprints;
generating a default set of slices from the default set of slice blueprints; and
using the default set of slices during said first period of time.

10. The method of claim 9, wherein the default set of slices includes at least a first slice of a first slice type corresponding to a first slice type blueprint, a second slice of a second slice type corresponding to a second slice type blueprint, a third slice of a third slice type corresponding to a third slice type blueprint and a fourth slice of a fourth slice type corresponding to a fourth slice type blueprint.

11. The method of claim 10, wherein operating an artificial intelligence engine to use the slice and slice parameter prediction model to automatically predict slices and slice parameters which are required for a future period of time includes:
predicting fewer slices being required in the future period of time than are included in said default set of slices, said fewer slices including a first slice of the first slice type, a second slice of the second slice type, and a third slice of the third slice type but not a slice of the fourth type slice.

12. The method of claim 11, wherein automatically generating the network slices predicted to be required for the future period of time includes allocating at least some resources previously allocated to the fourth slice corresponding to the fourth slice type to one or more of the first, second and third slices of the first set of slices.

13. The method of claim 12,
wherein the default set of slices includes a first slice which is a live stream slice, a second slice which is a gaming slice, a third slice which is a smart phones slice and a fourth slice which is a machines slice; and
wherein the first set of slices generated for said future period of time includes a live stream slice, a gaming slice and a smart phones slice, some network resources allocated to the machines slice of the default set of slices being reallocated to one or more of the slices in the first set of slices as part of automatically generating said first set of slices.

14. The method of claim 13, wherein said some network resources reallocated to one or more slices includes a number of processors, an amount of bandwidth, and an amount of storage.

15. A communications system, the system comprising:
a network communications core configured to collect information relating to UE use of a communications network during a first period of time; and
an artificial intelligence engine including:
a model training module configured to train a slice and slice parameter prediction model using collected information relating to UE use of the communications network during the first period of time;
a slice and slice parameter prediction model configured to automatically predict slices and slice parameters corresponding to predicted slices, which are required for a future period of time; and
an OSS in said network communications core configured to automatically generate network slices predicted to be required for the future period of time from slice blueprints to which the predicted slices correspond and the predicted slice parameters corresponding to predicted slices.

16. The system of claim 15, wherein the network core includes:
an AMF collecting UE device information corresponding to UEs accessing a communications network during a first period of time;
a UPF for collecting UE application type information indicting the type or types of applications being used by UEs accessing the communications network during the first period of time and for collecting quality of service information corresponding to the UEs accessing the communications network during the first period of time.

17. The system of claim 16, wherein the network core further includes an OSS for capturing network slice utilization information.

18. The method of claim 17, wherein the collected information on slice utilization includes information on the resources corresponding to each of the utilized slices which were used during said first period of time, different resources corresponding to different slice parameters.

19. The system of claim 16, wherein the model training module is configured to use collected information corresponding to the first period of time as training data, different sets of collected information corresponding to different network slices used during said first period of time being used as labeled training data to train the slice and slice prediction model.

20. The system of claim 19, wherein collected slice resource utilization information includes information which can be specified in a slice parameter, said information which can be specified in a slice parameter being used as a labeled parameter value corresponding to the particular network slice to which said information which can be specified in a slice parameter corresponds.
